(19) United States
(12) Patent Application Publication
(10) Pub. No.: US 2006/0148917 A1
(43) Pub. Date: Jul. 6, 2006

(54) Absorbent foam containing fiber

(76) Inventors: Fred Robert Radwanski, Stone Mountain, GA (US); Sridhar Ranganathan, Suwanee, GA (US); Mary Frances Mallory, Alpharetta, GA (US); Jeffrey Jennings Krueger, Marietta, GA (US)

Correspondence Address: KIMBERLY-CLARK WORLDWIDE, INC., 401 NORTH LAKE STREET, NEENAH, WI, 54956, US

(21) Appl. No.: 11/027,306

(22) Filed: Dec. 30, 2004

(51) Int. Cl. C08J 9/00

(52) U.S. Cl. 521/99

(57) ABSTRACT

A flexible, absorbent, thermoplastic foam comprises at least a thermoplastic base resin and fibers. The incorporation of fibers into the thermoplastic base foam structure can result in a foam which exhibits improved absorbent properties such as high fluid capillary action and improved fluid movement from cell to cell within the foam, while maintaining sufficient integrity and flexibility for specific applications. In some aspects, the use of fiber having high surface energy can increase the overall surface energy of the foam, which in turn can further enhance absorbent properties.

### BACKGROUND

The present invention concerns foam composites. More particularly, the present invention pertains to soft, flexible, absorbent, thermoplastic foam composites which can be utilized as an article, such as for packaging, wipers, towels, or insulation products including housewrap, or can be incorporated as a component into a variety of other articles, including personal care products, health/medical products, and household/industrial products, for example.

In general, absorbent foams have a cellular structure, with cells defined by cell membranes and struts. The struts are formed at the intersection of cell membranes, with the cell membranes covering interconnecting cellular windows between the struts. Foams may further contain cell orifices within the membranes that can provide doorways into adjoining cells. These orifices, or pores, if excessively small can create undesirable pressure drops, frictional losses, and tortuous paths that reduce fluid movement from cell to cell within the foam. Reticulated foams, which generally have a minimal number of cell membranes, or no cell membranes at all, but rather only struts, have been considered to help circumvent such flow problems. However, it is difficult to make fine reticulated foam with sufficiently small cell sizes for high fluid capillary action. Therefore, there is a need for a thermoplastic foam which overcomes such fluid flow problems.

Moreover, the surface energy of thermoplastic foams is generally insufficient for good absorbent functional properties, such as fluid intake, capacity, and capillarity. It may be desirable to use surfactants to improve wettability; however, surfactants also act to lower the fluid surface tension which may lower vertical capillary rise. Therefore, there is a further need for a thermoplastic foam with improved wettability without substantially lowering the fluid surface tension.

In the case of absorbent articles, it is recognized that such articles often include one or more absorbent layers capable of absorbing and retaining liquids. Some absorbent articles include a surge layer that is capable of quickly absorbing liquid, but is unable to retain a large quantity of liquid. A second absorbent layer having a higher absorbent capacity than a surge layer is often located below the surge layer such that the surge layer quickly takes in liquid and subsequently passes the liquid to the more absorbent layer to retain the liquid. Because of its many properties, such as aesthetics, flexibility, and absorbent properties, it may be desired to incorporate foams into such an article to perform at least one of the absorbing functions within the article. Therefore, there is a further desire for an article containing a thermoplastic foam that has sufficiently high flexibility, fluid storage and fluid capillary action and does not experience reduced fluid movement from cell to cell within the foam.

It is also recognized that certain products require good integrity. However, this can often conflict with obtaining sufficient absorbent and flexibility properties at the same time. Therefore, there is yet a further desire for a thermoplastic foam which exhibits good integrity, while maintaining sufficient absorbent and flexibility properties.

### SUMMARY

The present invention concerns foam composites. More particularly, the present invention pertains to a soft, flexible, absorbent thermoplastic foam which includes at least a thermoplastic base resin and fiber. In some aspects, a thermoplastic elastomer can also be added to enhance softness, flexibility, and elasticity. In other aspects, high surface energy fibers can be utilized to help connect cells within the foam and penetrate cell windows that partition the cells. By adding fibers which exhibit high surface energy, the overall surface energy correspondingly increases, which can enhance absorbent properties. The result is a thermoplastic foam which can exhibit high fluid capillary action and improved fluid movement from cell to cell within the foam, while maintaining sufficient integrity and flexibility for specific applications. The thermoplastic foam can be utilized as an article, such as a packaging, wiper, towel, or insulation product including housewrap, or can be incorporated as a component into a variety of other articles, including personal care articles, health/medical articles, and household/industrial articles, for example.

### BRIEF DESCRIPTION OF THE DRAWINGS

The foregoing and other features, aspects and advantages of the present invention will become better understood with regard to the following description, appended claims and accompanying drawings where:

FIG. 1 shows a schematic section through a portion of a thermoplastic foam according to a first aspect of the present invention;

FIG. 2 is a photomicrograph of an enlarged schematic section through part of a thermoplastic foam such as illustrated in FIG. 1. The photomicrograph was taken by scanning electron microscopy at a magnification of 30×;

FIG. 3 is an illustration of an exemplary process for making a thermoplastic foam;

FIG. 4 is an illustration of an exemplary process for making a fibrous web and for adding superabsorbent material to the web;

FIG. 5 is an illustration of an exemplary process for hydraulically needling a layer of fiber into a base foam layer;

FIG. 6 is a perspective view of one embodiment of an absorbent article that may be made in accordance with the present invention;

FIG. 7 is a plan view of the absorbent article shown in FIG. 6 with the article in an unfastened, unfolded and laid flat condition showing the surface of the article that faces the wearer when worn and with portions cut away to show underlying features;

FIG. 8 is a photomicrograph of a cross-section of a thermoplastic foam, described in Example 1, taken by scanning electron microscopy. The photomicrograph was taken at a magnification of 30×;

FIG. 9 is a photomicrograph of a cross-section of a thermoplastic foam, described in Example 2, taken by scanning electron microscopy. The photomicrograph was taken at a magnification of 120×;

FIG. 10 is a photomicrograph of a cross-section of a thermoplastic foam, described in Example 3, taken by scanning electron microscopy. The photomicrograph was taken at a magnification of 30×;

FIG. 11 representatively shows a partially cut away top view of a saturated capacity tester;

FIG. 12 representatively shows a side view of a Saturated Capacity tester;

FIG. 13 representatively shows a rear view of a Saturated Capacity tester;

FIG. 14a representatively shows a front view of a Bending Modulus tester; and

FIG. 14b is a perspective view of the Fixture Base of FIG. 14a.

Repeated use of reference characters in the present specification and drawings is intended to represent the same or analogous features or elements of the present invention.

### DEFINITIONS

It should be noted that, when employed in the present disclosure, the terms “comprises,” “comprising” and other derivatives from the root term “comprise” are intended to be open-ended terms that specify the presence of any stated features, elements, integers, steps, or components, and are not intended to preclude the presence or addition of one or more other features, elements, integers, steps, components, or groups thereof.

The term “absorbent article” refers to devices which can absorb and contain body fluids, and more specifically, refers to devices which are placed against or near the skin to absorb and contain the various fluids discharged from the body. The term “disposable” is used herein to describe absorbent articles that are not intended to be laundered or otherwise restored or reused as an absorbent article after a single use. Examples of such disposable absorbent articles include, but are not limited to, personal care absorbent articles, health/medical absorbent articles, and household/industrial absorbent articles.

The term “absorbent” refers to the ability of a material to provide an absorbent capacity of 3 g/g with an aqueous solution containing 0.9 weight percent sodium chloride as measured by the Saturated Capacity Test

The term “flexible” refers to the ability of a material to bend under an imposed load such that its Bending Modulus at 0.5 mm deflection is 1000 g/mm2 or lower as measured by the Bending Modulus test.

The term “base foam” refers to a foam which has been made in accordance with the present invention, but which does not yet contain fiber.

The term “cell” refers to a cavity contained in foam. A cell is closed when the cell membrane surrounding the cavity (i.e., enclosed opening, or cell window) is not perforated and has all membranes intact. Cell connectivity occurs when at least one wall of the cell membrane surrounding the cavity has orifices, or “pores,” that connect to adjacent cells, such that an exchange of fluid is possible between adjacent cells.

The term “compression” refers to the process or result of pressing by applying a force on an object, thereby increasing the density of the object.

The terms “elastomeric,” “elastomer,” “elastic,” and other derivatives of “elastomeric” are used interchangeably and refer to materials having elastomeric or rubbery properties. Elastomeric materials, such as thermoplastic elastomers and thermoplastic vulcanizates, are generally capable of recovering their shape after deformation when the deforming force is removed. Specifically, as used herein, elastomeric is meant to be that property of any material which upon application of an elongating force, permits that material to be stretchable to a stretched length which is at least about 25 percent greater than its relaxed length, and that will cause the material to recover at least 40 percent of its elongation upon release of the stretching elongating force. A hypothetical example which would satisfy this definition of an elastomeric material in the X-Y planar dimensions would be a one (1) inch sample of a material which is elongatable to at least 1.25 inches and which, upon being elongated to 1.25 inches and released, will recover to a length of not more than 1.15 inches. Many elastomeric materials may be stretched by much more than 25 percent of their relaxed length, and many of these will recover to substantially their original relaxed length upon release of the stretching, elongating force. In addition to a material being elastomeric in the described X-Y planar dimensions of a structure, including a web or sheet, the material can be elastomeric in the Z planar dimension. Specifically, when a structure is compressively loaded, it displays elastomeric properties and will essentially recover to its original position upon removal of the load. Compression set is sometimes used to help describe such elastic recovery. When compression is applied to an elastomeric structure, the structure may display elastomeric properties and then recover to near its original position upon relaxation. The elastic property can both form and retain the curvature shape of the absorbent structure with fluid and BM loading and with compression loading and unloading.

The term “extensible” refers to a material that is generally capable of being extended or otherwise deformed, but which does not recover a significant portion of its shape after the extension or deforming force is removed.

The term “hydrophilic” describes surfaces and fibers, or the surfaces of fibers, which have a high affinity for aqueous liquids and are wetted by the aqueous liquids when in contact with the surfaces. The degree of wetting of the materials can, in turn, be described in terms of the contact angles and the surface tensions of the liquids and materials involved. Equipment and techniques suitable for measuring the wettability of surfaces on particular fiber materials or blends of fiber materials can be provided by a CAHN SFA-222 Surface Force Analyzer System available from Thermo Electron Corporation, a business having offices located in Madison, Wis., U.S.A., or a substantially equivalent system. When measured with this system, fibers or surfaces having contact angles of less than 90° with water are designated “wettable” or hydrophilic, while fibers or surfaces having contact angles greater than 90° with water are designated “nonwettable” or hydrophobic.

The term “household/industrial articles” include construction and packaging supplies, products for cleaning and disinfecting, wipes, covers, filters, towels, disposable cutting sheets, bath tissue, facial tissue, nonwoven roll goods, home-comfort products including pillows, pads, mats, cushions, masks and body care products such as products used to cleanse or treat the skin, laboratory coats, cover-alls, trash bags, stain removers, topical compositions, laundry soil/ink absorbers, detergent agglomerators, lipophilic fluid separators, and the like.

The term “medical article” includes a variety of professional and consumer health-care products including, but not limited to, products for applying hot or cold therapy, hospital gowns, surgical drapes, bandages, wound dressings, covers, containers, filters, disposable garments and bed pads, medical absorbent garments, gowns, underpads, wipes, and the like.

The term “meltblown fiber” refers to fibers formed by extruding a molten thermoplastic material through a plurality of fine, usually circular, die capillaries as molten threads or filaments into converging high velocity gas (e.g., air) streams which attenuate the filaments of molten thermoplastic material to reduce their diameter, which may be to microfiber diameter. Thereafter, the meltblown fibers are carried by the high velocity gas stream and are deposited on a collecting surface to form a web of randomly dispersed meltblown fibers. Such a process is disclosed for example, in U.S. Pat. No. 3,849,241 to Butin et al., which is hereby incorporated by reference in a manner consistent with the present document. Meltblown fibers are microfibers which may be continuous or discontinuous, are generally smaller than about 0.6 denier, and are generally self-bonding when deposited onto a collecting surface. Meltblown fibers are sufficiently mobile as described in U.S. Pat. No. 4,950,531 to Radwanski et al., which is incorporated herein by reference in a manner that is consistent with the present document, to allow fiber embedment into a base foam structure with mechanical or hydraulic needling.

The term “nonwoven” and “nonwoven web” refer to materials and webs of material having a structure of individual fibers or filaments which are interlaid, but not in an identifiable manner as in a knitted fabric. The terms “fiber” and “filament” are used herein interchangeably. Nonwoven fabrics or webs have been formed from many processes such as, for example, meltblown processes, spunbond processes, air laying processes, and bonded-carded web processes. The basis weight of nonwoven fabrics is usually expressed in ounces of material per square yard (osy) or grams per square meter (gsm) and the fiber diameters are usually expressed in microns. (Note that to convert from osy to gsm, multiply osy by 33.91.)

The term “open-cell” refers to any cell in a foam that has at least one broken or missing membrane or an orifice in a membrane such that it is in communication with a neighboring cell. The term “open-cell foam” refers to a foam wherein 50% or more of the cells are open-cell.

The term “personal care article” includes, but is not limited to, absorbent articles such as disposable diapers, baby wipes, training pants, child-care pants, and other disposable garments; feminine-care products including sanitary napkins, wipes, menstrual pads, panty liners, panty shields, interlabial products, tampons, and tampon applicators; adult-care products including wipes, pads, containers, incontinence products, and urinary shields; and the like.

The term “polymer” generally includes but is not limited to, homopolymers, copolymers, including block, graft, random and alternating copolymers, terpolymers, etc., and blends and modifications thereof. Furthermore, unless otherwise specifically limited, the term “polymer” shall include all possible molecular geometrical configurations of the material. These configurations include, but are not limited to isotactic, syndiotactic, and atactic symmetries.

The term “spunbond” or “spunbond fiber” refers to small diameter fibers which are formed by extruding molten thermoplastic material as filaments from a plurality of fine capillaries of a spinnerette having a circular or other configuration, with the diameter of the extruded filaments then being rapidly reduced as taught, for example, in U.S. Pat. No. 4,340,563 to Appel et al.; U.S. Pat. No. 3,692,618 to Dorschner et al.; U.S. Pat. No. 3,802,817 to Matsuki et al.; U.S. Pat. No. 3,338,992 to Kinney; U.S. Pat. No. 3,341,394 to Kinney; U.S. Pat. No. 3,502,763 to Hartmann; U.S. Pat. No. 3,502,538 to Petersen;k and U.S. Pat. No. 3,542,615 to Dobo et al., all of which are hereby incorporated by reference in their entirety in a manner that is consistent with the present document. Spunbond fibers are quenched and generally not tacky when they are deposited onto a collecting surface to form a nonwoven web. Spunbond fibers are generally continuous and often have average deniers larger than about 0.3 denier, more particularly, between about 0.6 and 10 denier. In U.S. Pat. No. 5,547,746 to Burton et. al., which is incorporated herein by reference in a manner that is consistent with the present document, there is described small denier spunbond fibers that can be embedded into base foam structures with mechanical or hydraulic needling.

The term “staple fibers” means filaments or fibers which are natural or which are cut from a manufactured filament prior to forming into a web, and which have a length ranging from about 0.1-15 cm, more commonly about 0.2-7 cm. Such fibers may be bonded into a bonded-carded web.

The term “surfactant” refers to a compound, such as a detergent or wetting agent, that affects the surface tension of fluids.

The term “thermoplastic” describes a material that softens and/or flows when exposed to heat and which substantially returns to its original hardened condition when cooled to room temperature.

The term “foam formula” refers to the base resin and any additives that are combined and used in the foam-making process for the present invention. The term “foam melt” refers to the mixture of components of the foam formula after the mixture has been heated, but prior to cooling and setting of the mixture. The term “foam” and “foam composite” are used interchangeably to refer to the cooled and set mixture from a foam-making process, and having fibers incorporated. In general, the composition of the foam is considered to be generally equivalent to the composition of the foam formula.

The term “thermoplastic vulcanizate” describes a thermoplastic elastomer with a chemically cross-linked rubbery phase and is produced by dynamic vulcanization.

The term “viscous fluid” refers to a fluid having a viscosity greater than the viscosity of water, including such fluids as menses, menses simulant, fecal fluid, fecal fluid simulant, and the like.

These terms may be defined with additional language in the remaining portions of the specification.

### DETAILED DESCRIPTION

The present invention concerns foam composites. More particularly, the present invention pertains to a flexible, absorbent, thermoplastic foam comprising at least a thermoplastic base resin and fibers. The incorporation of fibers into the thermoplastic base foam structure can result in a foam which exhibits high fluid capillary action and improved fluid movement from cell to cell within the foam, while maintaining sufficient integrity and flexibility for specific applications. In some aspects, the use of fiber having high surface energy can increase the overall surface energy of the foam, which in turn can further enhance absorbent properties.

The foam is absorbent and is generally soft and flexible. In some aspects, a thermoplastic elastomer can also be added to the foam formula to further enhance softness, flexibility, and elastic properties. The foam can function as an article or as a component of an article, such as a fluid uptake layer or fluid storage layer, for absorbent articles. Additionally, the foam can have desirable properties including hand, tactile and other aesthetic properties, flexibility, compression resiliency, and softness. Such foam can additionally meet stringent chemical and safety guidelines for personal care and medical product applications as well.

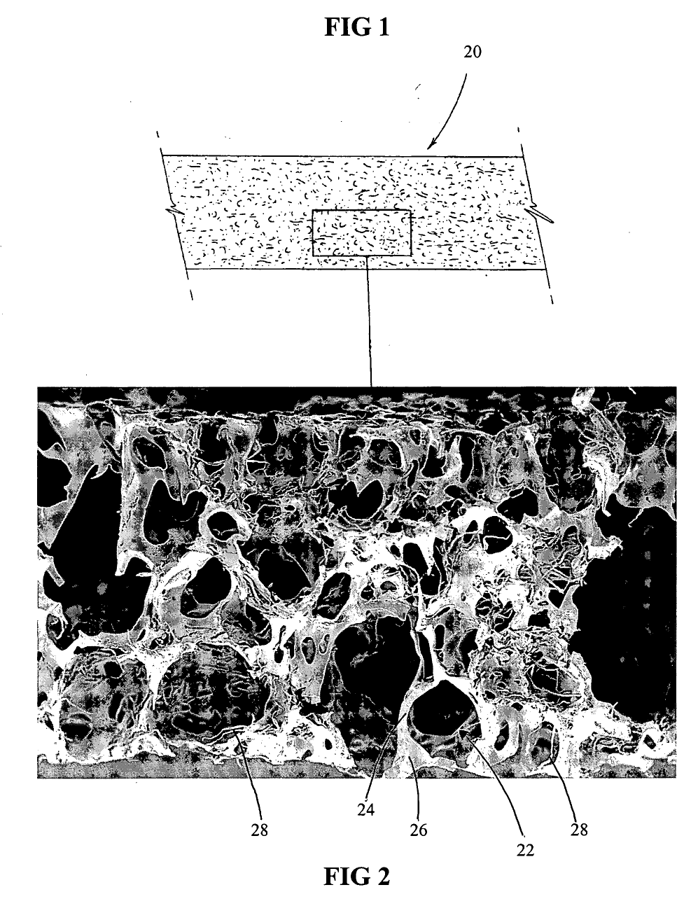

With reference to FIGS. 1 and 2 of the drawings, there is schematically illustrated a foam composite 20 according to a first aspect of the present invention. The foam composite 20 may define a plurality of open-cells 22 which are separated from one another by cell membranes 24 and struts 26. Fibers 28 are incorporated into the foam 20 so as to extend through the cell membranes 24 and struts 26 between adjacent or adjoining cells 22 in the foam 20. The walls of the cells 22 can be formed from a substantially non-absorbent material, and the cells 22 are in liquid communication with the fibers 28.

The thermoplastic foam can be hydrophilic and can contain a sufficient continuum of connecting cells with cell sizes that are small enough to generate sufficient capillary forces to draw and contain fluid. To further facilitate fluid management, cell size gradients in the X, and/or Y, and/or Z dimensions can also be incorporated. Suitable cell sizes may be in the range of about 10 microns to about 1000 microns as measured by ASTM D 3576. In some aspects, a “fine” foam can have foam cell sizes in the range of about 10 microns to about 500 microns, such as about 20 microns to about 300 microns. In other aspects, a “coarse” foam can have foam cell sizes in the range of about 500 microns to about 1000 microns. Generally, relatively smaller cell diameters are more suitable for higher capillary fluid movement (e.g., wicking), whereas relatively larger cell diameters are more suitable for faster fluid intake.

Various other properties of the foam composite can be manipulated during the formation process and/or post-formation processes such that the foam composite can perform optimally for specific applications. For example, cell membrane pores, which are small orifices in the cell membranes that connect neighboring cells within the foam structure, should be of sufficient number and size to minimize viscous drag and flow resistance to produce effective fluid transport and containment when used for absorbent applications. The specific number and size can be determined by the foam formula, as well as the processing parameters selected.

The foam can have desirable properties depending upon the application for which it is utilized. In general, a low foam density and low bending modulus are suitable for enhancing absorbency, softness, flexibility, hand, tactile and fit aesthetics for absorbent applications such as diapers, feminine care, and incontinence products. For example, in some aspects, the foam can have a bending modulus of about 500 g/mm² or less, such as about 100 to about 500 g/mm², as measured by the Bending Modulus Test. In one example, the thermoplastic foam had a bending modulus of 124 g/mm². In another example, the thermoplastic foam had a bending modulus of 305 g/mm².

The foam composite can additionally be extensible or elastic, and can have a low compression set. For example, in some aspects, the foam composite can have an elasticity of about 80% elongation using about 50 gm of force per one inch width of foam. The foam composite can also have desired compression set behavior. For example, in some aspects, the foam composite can have a compression set of less than 50%, more preferably less than 20% as measured by ASTM D 3575.

The foam composite can also have desired mechanical strength properties. For example, in some aspects, the foam composite can have a breaking force of greater than 1000 grams as measured by the Grab test described in ASTM D 5034.

The foam of the present invention generally comprises an open-cell structure. In some aspects, the foam composite can have an open-cell content of about 50% or greater, such as about 70% or greater, or 80% or greater, such as about 50% to about 95% or about 50% to about 85%, as measured by using a gas pycnometer according to ASTM D 2856, Method C.

The thermoplastic foam can also have desirable densities. For example, the density of such foams can suitably be in the range of about 0.01 g/cc to about 0.5 g/cc, or about 0.03 g/cc to about 0.4 g/cc, or about 0.05 g/cc to about 0.25 g/cc. In one example, the foam has a density in the range of about 0.06 g/cc to about 0.12 g/cc. Furthermore, densification of the foam at some point after the formation process can be employed to enhance functionality for specific applications.

The thermoplastic foam can also have desirable basis weights and bulks. For example, in some aspects, the foam can have a basis weight of about 300 gsm or less. In other aspects, the foam can have a bulk, which may or may not be pre-densified, of about 4 mm or less when measured under a load of 0.2 psi, such as when designed for personal care products.

The thermoplastic foam of the present invention may also have desirable absorbency properties as well. For example, in some aspects, the foam can have a Drop Intake test performance that is less than about 25 seconds, such as less than about 8 seconds, or less than about 2 seconds, or less than about 1 second. In other aspects, the foam can have a saturated capacity of about 3 grams/gram or greater as measured under a 0.5 psi loading. In still other aspects, the foam can have a viscous fluid saturation capacity of about 3 g/g or greater and a retention capacity of about 1 g/g or greater, as measured by the Viscous Fluid Saturated Capacity and Retention Capacity Test. In yet other aspects, the foam can have a vertical wicking height of about 5 cm or greater, such as between about 14 and about 20 cm. In still other aspects, the foam can have a wicking pickup of greater than 100 g/g/cm² such as between about 120 and 152 g/g/cm².

In one example of the invention, the foam composite is an open-cell, flexible, thermoplastic foam where the cell walls are substantially non-absorbent and where a majority of the fibers extend through the cell walls to connect at least one of the cells to another. In another example of the invention, the foam composite is an open-cell, thermoplastic foam comprised of about 50% to about 95% by weight of alkenyl aromatic base resin, about 10% to about 50% by weight of thermoplastic elastomer which has a styrenic block copolymer content of about 50% to about 80% by weight of the elastomer, about 0.05% to about 10% by weight of surfactant, and about 1% to about 90% by weight of cellulosic fiber.

The thermoplastic foam of the present invention is made of at least one thermoplastic polymer that can be heated, formed, and cooled repeatedly. The starting material used in the foam formula can include at least one suitable base resin which could include a single thermoplastic polymer, a blend of thermoplastic polymers, or a blend of thermoplastic and non-thermoplastic polymers. Examples of base resins suitable for use in the foam formula include styrene polymers, such as polystyrene or polystyrene copolymers or other alkenyl aromatic polymers; polyolefins including homo or copolymers of olefins, such as polyethylene, polypropylene, polybutylene, etc.; polyesters, such as polyalkylene terephthalate; and combinations thereof. For example, in some aspects, a suitable base resin includes STYRON 685D polystyrene resin, available from Dow Chemical Company, a business having offices located in Freeport, Tex. U.S.A.

Coagents and compatibilizers can also be utilized for blending such resins. Additionally, crosslinking agents can also be employed to enhance mechanical properties, foamability, and expansion. Such crosslinking may be accomplished by utilizing several means, including the use of electron beams or by chemical crosslinking agents such as organic peroxides.

It is suitable to utilize base resins which provide effective foamability, softness, and flexibility. In general, resins having branched polymer chains tend to be more foamable. As such, flexibility, softness, and foamability can be manipulated by utilizing several means, including the use of polymer side groups; the incorporation of chains within the polymer structure to prevent polymer crystallization; the lowering of the glass transition temperature; the lowering of a given polymer's molecular weight distribution; the adjusting of melt flow strength and viscous/elastic properties including elongational viscosity of the polymer melt; the use of block copolymerization; the blending of polymers; the use of polyolefin homopolymers and copolymers, including low (such as linear low), medium and high-density polyethylene and polypropylene which are normally made using Ziegler-Natta or Phillips catalysts and are relatively linear, as well as those that can be engineered with elastic and crystalline areas; the use of syndiotactic, atactic, and isotactic polypropylenes including those made using metallocene-based catalysts, as well as blends of such and other polymers; and the use of olefin elastomers.

In some applications, it is suitable to utilize resins which provide foam composites that are soft and extensible. Softness and extensibility can be manipulated using several means, including the use of ethylene and α-olefin copolymers, particularly those made using either Ziegler-Natta or a metallocene catalyst such as metallocene catalyzed polyolefins; the use of polyethylene cross-linked with α-olefins and various ethylene ionomer resins; and the use of ethyl-vinyl acetate copolymers with other polyolefin-type resins.

Common modifiers for various polymers can also be reacted with chain groups to obtain suitable functionality. This includes the use of alkenyl aromatic polymers and ionomer resins. Suitable alkenyl aromatic polymers include alkenyl aromatic homopolymers, copolymers of alkenyl aromatic compounds, copolymerizable ethylenically unsaturated comonomers including minor proportions of non-alkenyl aromatic polymers, and blends of such.

Thermoplastic base resins of the present invention may also contain blends of other polymers with the thermoplastic polymers, provided that the resulting foam remains thermoplastic. Such other polymers can include natural and synthetic organic polymers such as cellulosic polymers, methyl cellulose, polylactic acids, polyvinyl acids, polyacrylates, polycarbonates, starch-based polymers, polyetherimides, polyamides, polymethylmethacrylates, and copolymer/polymer blends.

As referenced above, the foam of the present invention also comprises fiber. Such fiber can, among other things, promote distribution and storage of fluids within the foam structure, as well as enhance overall surface energy for fluid uptake. The fiber can additionally improve the integrity and resiliency of the foam composite. Such fibers can be added as part of the foam formula and/or may be added through a post formation means.

The total fiber content in the final foam composite is preferably between about 1% and about 90% by weight of fiber with respect to the foam composite, such as between about 2% and about 50% by weight, or between about 3% and about 30% by weight. Suitable fibers can be hydrophilic, hydrophobic, or a combination thereof. In some aspects, these fibers can be high surface energy fibers. The fibers may comprise synthetic fibers, including meltblown, spunbond, and staple fibers, natural fibers, bicomponent fibers, or continuous filaments having various deniers and lengths. For example, natural fibers include silk, cotton, vegetable fibers, wood, and other cellulosic fibers; semi-synthetic fibers include acetate and premix; and synthetic fibers include polyethylene terephthalate (PET), rayon, nylon, modified hydrophilic polyolefins and hollow fibers, vinylon, vinylidene, vinyl chloride, polyester, acryl, polyethylene, polypropylene, and polyurethane fibers. Polymeric pulp fibers may also be used, although these tend to be less wettable than high surface energy cellulosic fibers. Blends of such fibers can also be suitable for the foam of the present invention. Mixtures of these fibers may also be used. For example, the fibrous component of the foam composite may contain from about 5% to about 50% by weight of synthetic fibers and from about 50% to 95% by weight of cellulosic fibers.

In general, the fibers utilized in the foam composite of the present invention can extend through at least one cell to connect to another cell, and desirably through multiple cells, thus reducing the tortuous fluid path that may otherwise exist in the foam cells. In some aspects, fine long fibers such as those with a fiber length greater than about 5 mm, including rayon and cotton, can be used to obtain desirable properties, such as enhanced fluid movement during wicking. In other aspects, fibers with a length of about 0.5 mm to about 5 mm, such as in the range of about 2 mm to about 5 mm (e.g., softwood fibers), can be used to provide a foam composite with an alternate balance of hydrophilic surface and resistance to fluid flow, which can result in faster intake while maintaining sufficient wicking. In still other aspects, short fibers in the range of 0.5 mm to about 3 mm (e.g. hardwood fibers, including Eucalyptus fibers) can be used to provide high hydrophilic surface area for liquid transport and improved capillarity.

In addition to the base resin polymers discussed above, the foam formula can optionally include at least one thermoplastic elastomer. For example, in some aspects, the foam formula can comprise at least about 5% by weight of thermoplastic elastomer, such as about 5% to about 50%, or about 20% to about 50% by weight of thermoplastic elastomer. In one particular aspect, the foam formula comprises substantially equal amounts of base resin and thermoplastic elastomer.

Suitable thermoplastic elastomers include, but are not limited to, rubbers, including natural rubber, styrene-butadiene rubber (SBR), polybutadiene, ethylene propylene terpolymers, and vulcanized rubbers, including TPVs; rubber-modified polymers such as styrene elastomers; ethylene elastomers; butadiene; polybutylene resins; diblock, triblock, tetrablock, or other multi-block thermoplastic elastomeric; and/or flexible copolymers such as polyolefin-based thermoplastic elastomers including random block copolymers including ethylene α-olefin copolymers; block copolymers including hydrogenated butadiene-isoprene-butadiene block copolymers; stereoblock polypropylenes; graft copolymers, including ethylene-propylene-diene terpolymer or ethylene-propylene-diene monomer (EPDM), ethylene-propylene random copolymers (EPM), ethylene propylene rubbers (EPR), ethylene vinyl acetate (EVA), and ethylene-methyl acrylate (EMA); and styrenic block copolymers including diblock and triblock copolymers such as styrene-isoprene-styrene (SIS), styrene-butadiene-styrene (SBS), styrene-isoprene-butadiene-styrene (SIBS), styrene-ethylene/butylene-styrene (SEBS), or styrene-ethylene/propylene-styrene (SEPS).

In one particular aspect, the foam formula utilizes KRATON, a thermoplastic elastomer available from Kraton Polymers, a business having offices located in Houston, Tex., U.S.A. In another particular aspect, the foam formula utilizes VECTOR SIS and SBS thermoplastic elastomers available from Dexco, a division of ExxonMobil Chemical Company, a business having offices located in Houston, Tex., U.S.A. In still another example, the foam formula utilizes SEPTON SEBS thermoplastic elastomer, available from Kuraray America, Inc., a business having offices located in New York City, N.Y., U.S.A.

Additional suitable thermoplastic elastomers include blends of thermoplastic elastomers with dynamic vulcanized elastomer-thermoplastic blends; thermoplastic polyether-ester elastomers; ionomeric thermoplastic elastomers; thermoplastic elastic polyurethanes such as LYCRA polyurethane, available from Invista, a business having offices located in Wichita, Kans. U.S.A., and ESTANE available from Noveon, Inc., a business having offices located in Cleveland, Ohio, U.S.A.; thermoplastic elastic polyamides, including polyether block amides such as PEBAX polyether block amide available from Atofina Chemicals, Inc., a business having offices located in Philadelphia, Pa., U.S.A.; thermoplastic elastic polyesters such as HYTREL available from Invista; and ARNITEL available from DSM Engineering Plastics, a business having offices located in Evansville, Ind., U.S.A.; and single-site or metallocene-catalyzed polyolefins having a density of less than about 0.89 grams/cubic centimeter, such as AFFINITY metallocene polyethylene resins available from Dow Chemical Company; and combinations thereof.

As used herein, a tri-block copolymer has an ABA structure where the A represents several repeat units of type A, and B represents several repeat units of type B. As mentioned above, several examples of styrenic block copolymers are: SBS, SIS, SIBS, SEBS, and SEPS. In these copolymers the A blocks are polystyrene and the B blocks are the rubbery component. Generally these triblock copolymers have molecular weights that can vary from the low thousands to hundreds of thousands and the styrene content can range from 5% to 75% as based on the weight of the triblock copolymer. A diblock copolymer is similar to the triblock but is of an AB structure. Suitable diblocks include styrene-isoprene diblocks which have a molecular weight of approximately one-half of the triblock molecular weight and have the same ratio of A blocks to B blocks. Diblocks with a different ratio of A to B blocks or a molecular weight larger or greater than one-half of triblock copolymers may be suitable for improving the foam formula for producing low-density, soft, flexible, and/or absorbent foam utilizing polymer extrusion.

It may be particularly beneficial to include a thermoplastic elastomer having a high diblock content and high molecular weight as part of the foam formula to extrude a low-density, soft, flexible, resilient, and/or absorbent thermoplastic foam. For example, the thermoplastic elastomer may have a diblock content between about 50% and about 80% by weight of the total thermoplastic elastomer weight.

KRATON thermoplastic elastomers can function as a discontinuous phase in styrenic-based foams and further function as cell-opening generators when used in small amounts. However, in larger amounts, the cell-opening effect may be somewhat secondary compared to the resiliency, flexibility, elasticity, and softness imparted.

The foam formula can also include blowing agents to aid in the foaming process and to help form a foamable melt. Both physical and chemical blowing agents, including both inorganic and organic physical blowing agents, can be used to create or enhance foaming. Chemical blowing agents, which are compounds that decompose at extrusion temperatures to release large volumes of gas; volatile liquids such as refrigerants and hydrocarbons; ambient gases such as nitrogen and carbon dioxide; water; or combinations thereof can be employed.

Suitable inorganic physical blowing agents include water, nitrogen, carbon dioxide, air, argon, and helium. Suitable organic blowing agents include hydrocarbons such as methane, ethane, propane, butanes, pentanes, hexanes, and the like. Aliphatic alcohols and halogenated hydrocarbons, including various FREON and fluorocarbons such as R-134A, can also be used (although their use may be avoided for environmental reasons). Endothermic and exothermic chemical blowing agents which are typically added at the extruder hopper include: azodicarbonamide, paratoluene sulfonyl hydrazide, azodiisobutyro-nitrile, benzene sulfonyl hydrazide, P-toluene sulfonyl hydrazide, barium azodicarboxylate, sodium bicarbonate, sodium carbonate, ammonium carbonate, citric acid, toluene sulfonyl semicarbazide, dinitroso-pentamethylene-tetramine, phenyltetrazole sodium borohydride, and the like.

In addition, mixtures and combinations of various physical and chemical blowing agents can be used to control cell structure. Blowing agent activators can also be added to lower the decomposition temperature/profile of such chemical blowing agents. Such blowing agent activators include metals in the form of salts, oxides, or organometallic complexes.

Blowing agents can be added directly to the foam formula or, alternatively, can be added after the melt temperature has been heated to a temperature at or above its glass transition temperature or melting temperature. The inlet for a blowing agent, such as in an extrusion process, is typically between the metering and mixing zones. The blowing agent is mixed thoroughly with the melted polymer at a sufficiently elevated pressure to prevent melt expansion. In some aspects, a blowing agent can be added to the foam formula in an amount between about 1% and about 10% by weight.

Other additives can also be included in the foam formula to enhance various properties. For example, a nucleating agent, or nucleant, can be utilized to improve foam gas bubble formation and to obtain desired fine open-cell structure. Examples of suitable nucleants include talc, magnesium carbonate, nanoclay, silica, calcium carbonate, blends of citric acid and sodium bicarbonate, coated citric acid/sodium bicarbonate particles, silica, barium stearate, diatomaceous earth, titanium dioxide, pulverized wood, clay, calcium stearate, stearic acid, salicylic acid, fatty acids, metal oxides, modified nucleant complexes, and combinations thereof. An example of a commercially available nucleant is a nanoclay available under the trade name CLOISITE 20A, available from Southern Clay Products, Inc., a business having offices located in Gonzales, Tex., U.S.A. Various thermoplastic polymers may also be used for such purposes.

Nucleants are typically dry blended or added with the polymer concentrate. The amount of nucleant will vary based upon several parameters, including the cell structure desired, foaming temperature, pressure, polymer composition, and type of nucleating agent utilized. For example, in some aspects, a nucleant can be added to the foam formula in an amount between about 0.1% and about 5% by weight. Typically, as the amount of nucleant increases, the cell density likewise increases.

Still other additives that can be utilized with the invention include surface active agents (i.e., surfactants). Surfactants may be utilized to control properties such as surface tension, foam formation, and wettability.

In general, while forming the foam composite, the bubble walls may tend to drain due to factors such as gravity and capillary forces. Such drainage often thins the walls before the cell struts, or ribs, are sufficiently hardened, which in turn can result in cell collapse. It has been proposed that capillary pressure at the junction of two or more struts tends to be lower, thereby creating flow from the membrane to the struts and, consequently, thinning the cell membrane. With a sufficient amount of surfactant molecules arranged preferentially to migrate to the surface of the film membrane, the presence of surfactant at the membrane's thin film surfaces may provide resistance to drainage of the molten plastic. If the film layer is sufficiently thick, such as in a foam cell membrane, it can be further stabilized by an ionic double layer of molecules resulting from orientation of ionic surfactants. Both nonionic and ionic surfactants can exhibit another stabilizing force if the membrane is sufficiently thin. This can be accomplished through alignment of surfactant tails to create a bi-layer structure, such as that found in biological cells, which are held together by Van der Waals forces, thus stabilizing the foam cell membrane. See Polymeric Foams, edited by D. Klempner and K. Frisch, Hanser Publishers, 1991; Foam Extrusion, edited by S. T. Lee, Technomic Publishing Co., Inc., 2000; Polymeric Foams, edited by S. T. Lee and N. S. Ramesh, CRC Press, 2004, and Polymeric Foams and Foam Technology, 2^{nd} Edition, edited by D. Klempner and V. Sendijarevic, 2004.

While it is not intended to limit the invention to a particular theory, it is believed that surfactant also provides resistance to diffusion of gas from a foam cell to the surroundings, which aids in resisting collapse. The reduced gas permeability due to the drainage resistance is related to the degree that a surfactant can pack into a foam cell's film surface and might explain the difference between the performances of the various surfactants. This reduced rate of diffusion allows sufficient cooling for strut formation to prevent coalescence. The surfactant does not necessarily need to completely prevent drainage, but rather can slow it sufficiently so that cell struts are substantially cooled and hardened, thereby preventing cell coalescence. In general, surfactants which tend to be highly mobile in the melt, highly surface active, and/or can pack tightly to help prevent membrane drainage will typically provide superior cell stabilization.

Suitable surfactants for the absorbent composite can be single-component or multi-component surfactants. A multi-component surfactant is a combination of two or more surfactants. It has been found that certain multi-component surfactants can achieve equal or better foam formation at a lower dosage than certain single-component surfactants. For example, in some aspects, foams utilizing a multi-component surfactant have densities comparable to foams made with over three times the amount of a single-component surfactant. Since surfactant tends to be a costly additive, the use of certain multi-component surfactants can result in foam composites having comparable foam properties at a lower cost than foams which include higher amounts of single-component surfactant.

Surfactants can be added at various locations in the foam-making process, such as directly in the foam formula, in the composition during the foaming process, and/or as a post-treatment after formation of the foam composite. In one aspect, for example, the surfactant can be added to the foam formula in a gaseous phase, such as through the use of a blowing agent, such as supercritical carbon dioxide.

Examples of suitable surfactants include cationic, anionic (including alkylsulfonates), amphoteric, and nonionic surfactants. Exemplary surfactants include SCHERCOPOL OMS-NA, a disodium momooleamido MEA sulfosuccinate, available from Scher Chemicals, Inc., a business having offices located in Clifton, N.J., U.S.A., and PLURONIC F68, a polypropylene glycol non-ionic surfactant which is a block copolymer of propylene oxide and ethylene oxide, available from BASF Corporation, a business having offices located in Florham Park, N.J., U.S.A. Other examples include HOSTASTAT HS-1, available from Clariant Corporation, a business having offices located in Winchester, Va., U.S.A.; EMEREST 2650, EMEREST 2648, and EMEREST 3712, each available from Cognis Corporation, a business having offices located in Cincinnati, Ohio, U.S.A.; and DOW CORNING 193, available from Dow Corning Corporation, a business having offices located in Midland, Mich., U.S.A. Alkyl sulfonates can also be suitable as a surfactant, although use of this class of surfactants in certain applications may be limited because of product safety concerns. However, some combinations of surfactants offer benefits where an alkyl sulfonate is added at a substantially lower level in conjunction with another surfactant(s) to yield good foaming and wettability.

The amount of surfactant utilized will vary depending upon the particular surfactant, as well as the properties desired. For example, in some aspects of the invention, the surfactant can be utilized in the foam formula in an amount between about 0.05% and about 10% by weight, such as between about 0.1% and about 5% by weight. In one feature, the surfactant is a multi-component surfactant utilized in the foam formula in an amount between about 0.05% and about 8.0% by weight, such as between about 0.1% and about 3.0% by weight.

Absorbency can be enhanced using superabsorbent polymer blends. It can also be enhanced with the use of superabsorbent material. Such superabsorbent material can be selected from natural, synthetic, and modified natural polymers and materials. The superabsorbent material can be inorganic materials, such as silica gels, or organic compounds, such as crosslinked polymers. The term “crosslinked” refers to any means for effectively rendering normally water-soluble materials substantially water insoluble, but swellable. Such means can comprise, for example, physical entanglement, crystalline domains, covalent bonds, ionic complexes and associations, hydrophilic associations, such as hydrogen bonding, and hydrophobic associations or Van der Waals forces.

Examples of synthetic, polymeric, superabsorbent materials include the alkali metal and ammonium salts of poly(acrylic acid) and poly(methacrylic acid), poly(acrylamides), poly(vinyl ethers), maleic anhydride copolymers with vinyl ethers, and alpha-olefins, poly(vinyl pyrolidone), poly(vinyl morpholinone), poly(vinyl alcohol), and mixtures and copolymers thereof. Further polymers suitable for use in the absorbent composite include natural and modified natural polymers, such as hydrolyzed acrylonitrile-grafted starch, acrylic acid grafted starch, methyl cellulose, carboxymethyl cellulose, hydroxypropyl cellulose, and the natural gums, such as alginates, xanthum gum, locust bean gum, and the like. Mixtures of natural and wholly or partially synthetic absorbent polymers can also be useful. Processes for preparing synthetic, absorbent gelling polymers are disclosed in U.S. Pat. No. 4,076,663 to Masuda et al. and U.S. Pat. No. 4,286,082 to Tsubakimoto et al., all of which are incorporated herein by reference in a manner that is consistent herewith.

The superabsorbent material may be in a variety of geometric forms. In one example, the superabsorbent material is in the form of discrete particles. However, the superabsorbent material may also be in the form of fibers, flakes, rods, spheres, needles, particles coated with fibers, or other additives, films, and the like.

Superabsorbent materials suitable for use in the present invention are known to those skilled in the art. Generally stated, the superabsorbent material can be a water-swellable, generally water-insoluble, hydrogel-forming polymeric absorbent material, which is capable, under the most favorable conditions, of absorbing at least about 10 times its weight, or at least about 15 times its weight, or at least about 25 times its weight in an aqueous solution containing 0.9 weight percent of sodium chloride. The hydrogel-forming polymeric absorbent material may be formed from organic hydrogel-forming polymeric material, which may include natural material such as agar, pectin, and guar gum; modified natural materials such as carboxymethyl cellulose, carboxyethyl cellulose, chitosan salt, and hydroxypropyl cellulose; and synthetic hydrogel-forming polymers. Synthetic hydrogel-forming polymers include, for example, alkali metal salts of polyacrylic acid, polyacrylamides, polyvinyl alcohol, ethylene maleic anhydride copolymers, polyvinyl ethers, polyvinyl morpholinone, polymers and copolymers of vinyl sulfonic acid, polyacrylates, polyvinyl amines, polyquaternary ammonium, polyacrylamides, polyvinyl pyridine, and the like. Other suitable hydrogel-forming polymers include hydrolyzed acrylonitrile grafted starch, acrylic acid grafted starch, and isobutylene maleic anhydride copolymers, and mixtures thereof. The hydrogel-forming polymers are desirably lightly crosslinked to render the material substantially water insoluble. Crosslinking may, for example, be by irradiation or covalent, ionic, Van der Waals, or hydrogen bonding.

Suitable base superabsorbent materials are available from various commercial vendors, such as Stockhausen, Inc., BASF Inc., and others. For example, the superabsorbent material can be FAVOR SXM 9394, available from Stockhausen, Inc., a business having offices located in Greensboro, N.C., U.S.A. The superabsorbent material may desirably be included in an appointed storage or retention portion of the foam system and may optionally be employed in other components or portions when the foam composite is used in an absorbent article. In one feature, the superabsorbent material can be selectively positioned within the foam composite such that the foam composite comprises regions of varying superabsorbent material concentration.

Superabsorbent materials can be incorporated into the foam of the present invention externally or by in-situ polymerization. Superabsorbent material may be present at a concentration of up to about 95% superabsorbent material by weight, such as about 10% to about 90% by weight, or about 15% to about 85% by weight.

Various other additives such as lubricants, acid scavengers, stabilizers, colorants, adhesive promoters, fillers, smart-chemicals, foam regulators, various UV/infrared radiation stabilizing agents, antioxidants, flame retardants, smoke suppressants, anti-shrinking agents, thermal stabilizers, anti-statics, permeability modifiers, and other processing and extrusion aids including mold release agents, anti-blocking agents, and the like can also be added to the foam formula.

Once the desired ingredients of the foam formula have been determined, the materials can be added together and prepared to be formed in a foam-making process. The base foam (i.e., prior to external incorporation of fibers) can be made from foam-making processes known in the art. For example, in some aspects, various continuous plastic extrusion processes known in the art can be utilized to produce the base foam. Other suitable foam making processes known in the art include injection molding, batch processes, and frothing processes.

In general, the materials can be heated such that the materials form a molten foam melt, at which time the materials can form a substantially homogeneous mixture. In some aspects, the materials are suitably heated to a temperature between about 100 and about 500 degrees Celsius to create the foam melt. Such foam melt can then be foamed to create cells within the melt using suitable foaming techniques known to those skilled in the art. Once formed, the foam melt can then be processed, such as with an extrusion process, and cooled to form the foam composite.

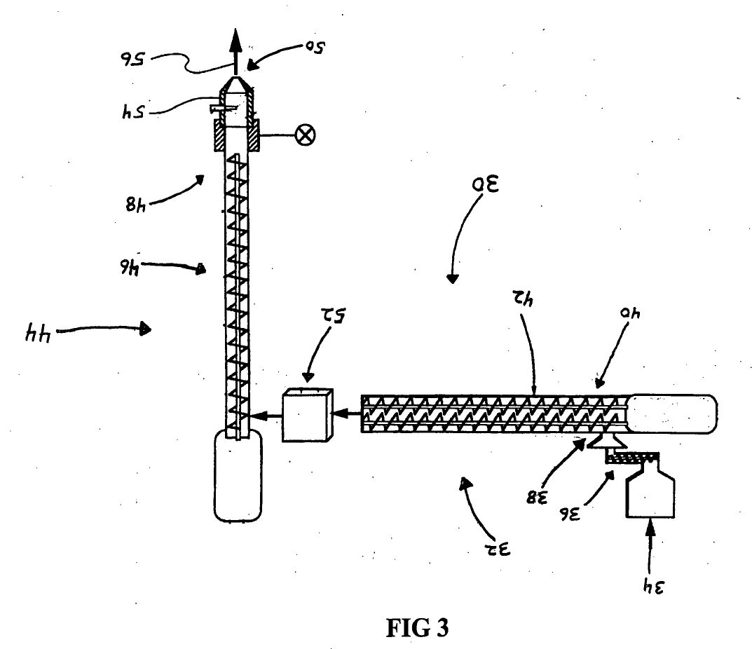

In some aspects, continuous plastic extrusion processes known in the art can be utilized to produce the foam composite. In the case of such extrusion processes, a tandem screw-type extruder, such as illustrated in FIG. 3, can be utilized. This type of extruder 30 may be considered particularly suitable in some aspects because it has the ability to provide tight control of extrusion temperatures to produce open-cell foam. With tandem extruders 30, the first extruder section 32 typically contains several zones including a feed zone 34, a conveying zone 36, a compression zone 38, a melting zone 40, and a metering and mixing zone 42. The second extruder section 44 often contains a cooling zone 46 and a shaping zone 48 prior to the discharge 50. The first extruder 32 is typically hopper loaded with the base resin(s) as well as any other optional additives, including thermoplastic elastomer(s) and fibers. Techniques known in the art for accomplishing this include using dry blend/metering equipment and/or having the components incorporated into a pelletized polymer concentrate such as in a masterbatch. The components of the foam formula are then heated in the extruder 32 to form a plasticized or melt polymer system.

The foamable melt is then typically cooled to a lower temperature to control the desired foam cell structure. In the case of tandem extruders 30, the cooling is typically accomplished in the second extruder 44 which is connected downstream of the first extruder 32 through a heated cross-over supply pipe 52. In the case of single extruders (not shown), cooling is typically accomplished upstream of the discharge orifice. Often cooling/heating systems with process temperature control loops are incorporated to tightly control foam bubble nucleation/growth within the gas-laden melt. The optimum cooling temperature for foam formation is typically at or slightly above the glass transition temperature or melting point of the melt.

The melt is then extruded through a die 54 to a lower pressure (typically atmospheric or a vacuum) and lower temperature (typically ambient) environment to cause thermodynamic instability and foaming which then cools and crystallizes the plastic to form a stabilized foam 56 which then solidifies to form a web or layer. Often circular, annular or slit dies, including curtain dies, and the like are used, often with a mandrel, to shape and draw the web to the desired gauge, shape, and orientation with foam expansion and cooling.

Various equipment configurations using such extrusion can be used to manufacture the foam composite of the present invention. In addition, various specialized equipment can be employed upstream of specially designed dies to enhance mixing, cooling, cellular structure, metering, and foaming. Such equipment includes static mixers, gear pumps, and various extruder screw designs, for example. Stretching equipment, including roller nips, tenters, and belts, may also be used immediately downstream of the discharge to elongate cellular shape to enhance absorbency. Microwave irradiation for cross-linking, foaming activation, and mechanical means can also be used to enhance foam properties. Foam contouring, shaping (e.g. use of a wire mesh pattern) and the like, using thermoforming, and other such thermal processes, including thermal bonding, can be used to control shaping, flexibility, softness, aesthetics, and absorbent swelling.

Open-cell formation can be regulated by elevated processing pressures and/or temperatures, as well as by using additives such as nucleating agents, chemical blowing agents, and low additions of immiscible polymers, and/or surfactants which can control both cell density and cell structure. Particular base resins are also sometimes used to broaden the foaming temperature to make open-cell foam. For example, the open-cell level of a polystyrenic-based foam can be facilitated by adding small amounts of various immiscible polymers to the foam formula, such as by adding polyethylene or ethylene/vinyl acetate copolymer, to create interphase domains that cause cell wall rupture. In another example, ethylene-styrene interpolymers can be added to alkenyl aromatic polymers to control open-cell quality, and to improve surface quality and processability. In still another example, small amounts of polystyrene-based polymers can be added to polyolefin-based foams to increase open-cell content. The open-cell content and microporous cell membrane uniformity can also be controlled by regulating the polymer system components and crystallization initiating temperature.

Suitable base foams may be available commercially. For example, MINICELL STD, a crossed-linked polyethylene, available from Voltek, Division of Sekisui America Corporation, a business having offices located in Lawrence, Mass., U.S.A. Suitable base foams are also described in U.S. Pat. No. 6,627,670 Mork et al.; U.S. Pat. No. 5,260,345 to DesMarais et al.; U.S. Pat. No. 6,071,580 to Bland et al.; and pending U.S. patent application Ser. No. 10/729,881 filed Dec. 5, 2003 by Krueger et al., all of which are incorporated herein by reference in a manner that is consistent herewith.

As referenced above, the foam of the present invention further comprises fiber. Various methods can be used to incorporate fibers into the foam. In some aspects, the fiber can be incorporated into the foam formula to form a homogeneously integrated foam composite. One suitable method to accomplish this is to incorporate the fibers during the foam extrusion process. For example, the fibers may be introduced into the feed hopper or the melt stream of a continuous extruder. In such a case, the glass transition temperature, the melt temperature, and the decomposition temperature of the fibers must be higher than the temperatures encountered in the extruder. The fiber could alternatively be added in the die land area or at the discharge orifice of the extruder, in which case the fiber melt, glass transition, and decomposition temperatures may be lower due to reduced exposure time and temperature. Extruder dwell times can also be important for many materials including cellulosic materials. Fibers that are suitable for this type of incorporation include, but are not limited to, cellulosic fibers such as wood pulp, vegetable-based pulp including abaca and flax, cotton, rayon, PET, and/or nylon fibers. One exemplary extrusion process is described in U.S. Pat. No. 4,832,889 to Johnson which is incorporated herein by reference in a manner consistent herewith.

In other aspects, the fibers may additionally or alternatively be incorporated into the base foam using external means. For example, an air-forming process may be used where individual fibers are suspended within air streams using conventional entrainment equipment. The base foam can then be pre-stretched to open up the structure sufficiently to allow the air conveyed fiber to be deposited into the openings of the base foam structure. The base foam can then be relaxed and the fibers can be sufficiently contained within the base foam's structure.

In other aspects, the fibers may be additionally or alternatively incorporated into the foam through post-foam formation means. Such means may require that the fibers be processed into a fibrous web prior to incorporation into the base foam. Various fibrous web formation processes known in the art can be utilized to create the fibrous web, including, but not limited to, wet-laid, carding, nonwoven, and air-laid processes.

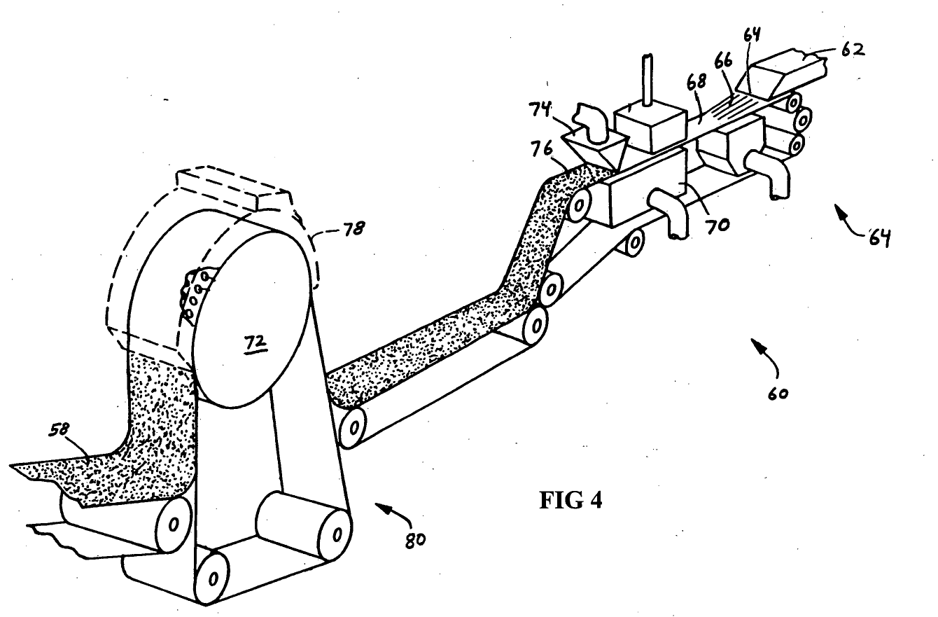

FIG. 4 illustrates an exemplary wet-laid process and apparatus 60 for forming a suitable fibrous web 58. The fibrous web 58 may be formed by first mixing the fibers with water to form a dilute suspension of the fibers and then supplying the suspension to a headbox 62 on a papermaking machine 64. The suspension of fibers may be diluted to any consistency which is typically used in conventional wet-laying processes. For example, a wood fiber suspension may contain from about 0.01% to about 5% percent by weight of fibers suspended in water. Suspensions containing synthetic and/or semi-synthetic fibers can be even lower, such as about 0.005% by weight.

The pulp fibers may be unrefined or may be beaten to various degrees of refinement. Additionally, amounts of chemical additives may be added to improve various properties such as absorbency, strength or abrasion resistance. Debonding agents and or other softening agents may also be added to the pulp mixture to reduce the degree of hydrogen bonding (i.e., paper bonding) if a very open or loose (e.g., softer) fiber web is desired.

From the headbox 62, the suspension of fibers travels through a sluice 64 and is deposited on a foraminous surface 66 where water is removed to form a uniform nonwoven web of fibers 68. The web of fibers 68 can then be de-watered in a nip (not shown) and/or by using vacuum pressure from a vacuum box 70, and dried with a dryer 72, which can include through-air dryers, can dryers, infrared, Yankee dryers, or other drying means known in the art. The dryer section may also include a gas heated hood 78 which can partially surround the dryer 72. The temperature of the dryer section 80 may range from about 300 degrees F. (149 degrees C.) to about 500 degrees F. (260 degrees C.) or higher. Use of creping and other well-known mechanical means can also be employed to generate soft textile-like webs.

Once the fibrous web has been formed, it may be incorporated into the foam using various means. Suitably, post-foam formation means, such as hydraulic and/or mechanical needling, hydraulic or pneumatic jet treatments, air forming, and the like may be utilized. Such incorporation may be accomplished alternatively, or in addition to, incorporating fibers during the foam formation process.

For example, in some aspects, the fibers are hydraulically needled or jetted into the foam structure. In essence, hydraulic needling utilizes pressurized columnar streams of fluid to force fibers into the foam layer such that individual fibers pierce through the cell walls and are intertwined into the strut cellular structure, potentially connecting several cells with each fiber, thus creating a fiber incorporated foam composite.

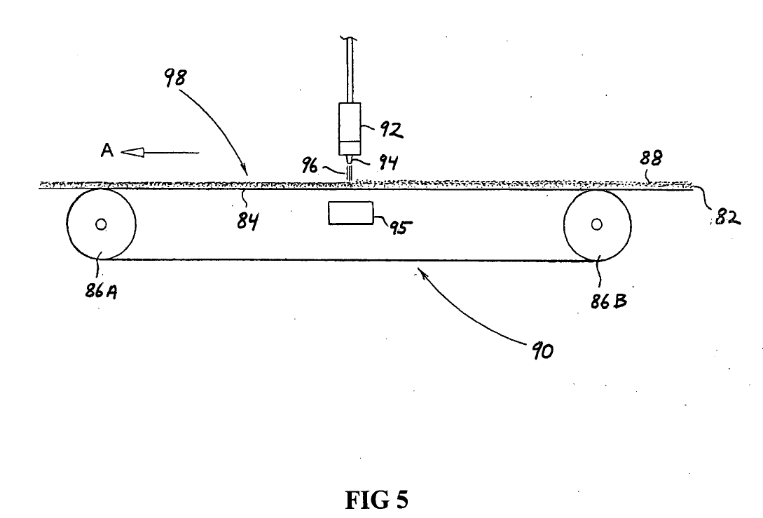

FIG. 5 illustrates one exemplary process for hydraulically needling a layer of fibers into the foam structure. In this example, a foam layer 82 is supported on an apertured foraminous support or carrier belt 84 of a hydraulic needling machine 90. The carrier belt 84 is supported on two or more rolls 86A and 86B provided with suitable driving means (not shown) for moving the belt 84 forward continuously. The carrier belt 84 may, for example, be a single plain weave foraminous wire having a mesh size from about 20 to about 150. Alternatively, a perforated plate (not shown) can be utilized as a backing carrier.

A fibrous web 88 which may be dry or hydrated to a specific consistency is positioned adjacent to and in facing relationship with the foam layer 82. Typically, a wood/vegetable fibrous web is at a consistency between about 15% to about 100% by weight solids. The composite of layers 82,88 is then passed under one or more manifolds 92. The hydraulic needling process may be carried out with any appropriate working fluid such as, for example, water. The working fluid is generally evenly distributed by the manifold 92 through a series of individual holes or orifices 94 which may be from about 0.003 to about 0.015 inch in diameter. In some aspects, the working fluid passes through the orifices 94 at a pressure generally ranging from about 50 to about 3000 pounds per square inch gage (psig), such as about 60 to about 1500 psig or about 100 to about 800 psig, or even about 200 to about 600 psig. In general, nonwoven fibrous webs that contain mostly cellulosic fibers may utilize a fluid pressure ranging from about 60 to about 400 psig, when one to four manifolds are used. However, greater needling energy may be required for high basis weight materials, nonwoven fibrous webs containing large proportions of long fibers (such as synthetic fibers including meltblown, spunbond, and staple fibers), or fibers having a stiffer modulus, or higher line speeds, and the like.

The resulting columnar jetted streams 96 of the working fluid impact on the fibrous web 88 which needles the fibers into the foam structure 82, thereby creating the foam composite 98 of the present invention. Additionally, vacuum slots in a suction box(es) 95 may be located directly beneath the hydraulic needling manifold(s) 94 and beneath the carrier belt 84 as well as downstream of the needling manifold(s) 94 to remove excess water from the hydraulically jet treated composite material 98. The foam-fiber composite 98 can then be dried using means known in the art.

Water jet treatment equipment and other hydraulic needling equipment and processes which may be adapted can be found, for example, in U.S. Pat. No. 3,485,706 to Evans, and in an article by Honeycomb Systems, Inc. entitled “Rotary Hydraulic Entanglement of Nonwovens,” reprinted from INSIGHT 86 INTERNATIONAL ADVANCED FORMING/BONDING CONFERENCE, both of which are incorporated herein by reference in a manner consistent with this disclosure. In some aspects, the invention may be practiced using a manifold containing a strip having 0.007 inch diameter orifices, 30 orifices per inch and one row of orifices such as that produced by Metso Paper USA, Inc. a business having offices located in Biddeford, Me., U.S.A. Other manifold configurations and combinations such as those available from Fleissner GmbH, a business having offices in Egelsbach, Germany or Rieter Perfojet S.A., a business having offices located in Winterthur, Switzerland, may also be used. For instance, in some aspects a single manifold may be utilized, whereas in other aspects several manifolds may be arranged in succession. In addition to manipulating needling process parameters, other variables such as the basis weight of the pulp needled, the depth of fiber penetration into the foam structure, the fiber length, and the ratio of needled fiber to foam can be controlled to obtain desired properties.

As a result of the needling process or similar methods, the fibrous layer and the base foam layer can benefit from an intimate continuity which enhances fluid transfer movement back and forth between them. Additionally, such continuity promotes the layers to act synergistically resulting in enhanced liquid handling behavior of the composite. Furthermore, when high surface energy fibers are utilized in the fibrous layer, the needling process can reorient and reposition the fibers in the z-direction of the foam such that more high surface energy fibrous surfaces and pores are available for fluid pickup and transfer throughout the foam. This in turn can enhance capillary action and fluid capacity. For example, in the case of a laminate such as described above, the layer of fibers can, among other things, enhance fluid distribution across the surface of the base foam layer, while fibers needled within the foam layer can, among other things, enhance fluid distribution within the base foam layer. The result is that fluid can be more readily distributed across the fiber layer, more readily transferred into the foam layer, and more readily distributed through the foam layer, thereby improving fluid intake and storage.

In one feature, superabsorbent material can be deposited on at least one surface of the fiber-incorporated foam composite. In the case of hydraulic needling, this typically occurs after the water-jet treatment(s) to avoid superabsorbent hydration and swelling. However, the superabsorbent material could be added prior to water-jet treatment(s) as well. For example, the material may be placed on top of the fiber layer, or could be sandwiched between the fiber layer and the foam layer, prior to exposing the materials to hydraulic needling. In another example, the superabsorbent material may be incorporated into the fiber layer during a fiber web formation process. If superabsorbent material is deposited before fluid jet treatment, it is preferred that the superabsorbents are those which can remain inactive during the fluid jet treatment step and can be activated at a later time.

Methods known in the art for incorporating superabsorbent materials into hydraulically needled webs may be suitable for the present invention, such as that described in U.S. Pat. No. 5,328,759 to McCormack et al., which is incorporated herein by reference in a manner that is consistent herewith. For example, with reference to FIG. 4, a fibrous nonwoven web 68 using a conventional superabsorbent material handling system 74 is shown. As the fibrous web 68 passes under the superabsorbent material handling system 74, superabsorbent material 76 is deposited onto the web at a desired add-on level. The web can then be transferred to a drying operation 80. Exemplary handling systems are described in, for example, U.S. Pat. No. 4,604,313 to McFarland et al., which is incorporated herein by reference in a manner that is consistent herewith. Useful handling systems include various engraved roll volumetric feeders as well as other commercial systems such as, for example, CHRISTY dry material dispensing machines available from the Christy Machine Company, a business having offices located in Fremont, Ohio U.S.A.; and MELTEX SAP series powder application systems available from the Nordson Corporation, a business having offices located in Westlake, Ohio, U.S.A., as well as commercial systems available from Moller & Jochumsen, a business having offices located in Horsens, Denmark; and Danweb Forming International, a business having offices located in Aarhus, Denmark.

In addition to the above, secondary post-treatment processes can be performed to improve, among other things, absorbency, cellular orientation, aesthetics, softness, and similar properties. This can be accomplished through numerous techniques known in the art including mechanical needling and other mechanical perforation (such as to soften foam and increase open-cell content), stretching and drawing (such as for cellular orientation and softening), calendaring or creping (such as to soften and rupture cell membranes to improve cellular intercommunication), brushing, scarfing, buffing/sanding, and thermoforming (such as to shape the foam composite). Often a foam surface skin may form during extrusion, which can later be skived or sliced off, needle-punched, brushed, scraped, buffed, scarved, sanded, or perforated to remove the barrier. Depending on the specific usage of the foam, application of a surfactant after the foaming process or needling process may further be utilized to afford a desired wettability.

The foam composite of the present invention can be further incorporated with a reinforcing material such as scrim, spunbond, meltblown, netting, or woven material. For example, in a foam composite laminate, an open-mesh reinforcing member, such as spunbond, may be sandwiched between the fiber layer and the foam layer prior to exposing the materials to hydraulic needling. Inclusion of such a material could serve to improve wet strength and integrity, shape the web, and to curtail possible hydrated foam expansion.

The thermoplastic foam of the present invention can be utilized for numerous articles such as a packaging, wiper, absorbent mat, or insulation product, or can be incorporated as a component into a variety of other articles, including personal care articles, health/medical articles, and household/industrial articles. The foam can also be used in a wide array of applications including clothing components, filters, thermal and acoustic insulation, shock and cushion absorbing products, athletic and recreation products, construction and packaging uses, and cleaning applications such as sponges and wipes for oleophilic and/or hydrophilic fluids.

As mentioned above, the foam of the present invention can be utilized directly as an article or can be utilized as a component of an article. The foam can also be further combined with other various layers to form laminates, which can also then be utilized as an article or as a component of an article. For example, a stretchable nonwoven layer comprising superabsorbent material may be bonded to the foam using techniques known in the art, such as by adhesive or thermal bonding, to form a laminate. Fibers can further be incorporated into the laminate, such as by hydraulic or mechanical needling, so as to form fiber pathways for directing fluid through the foam layer and into the layer comprising superabsorbent material. Alternatively, a foam layer may be hydraulically needled with a fibrous layer, and the composite may then be thermally laminated to another foam layer with pockets of superabsorbent material strategically sandwiched between the foam and the foam composite layers.

In some aspects, the foam composite is a laminate which functions as an absorbent core component of an absorbent article. In this example, the foam composite generally utilizes the foam layer for storing fluid and the fibrous layer for distributing fluid through the foam layer. More specifically, the foam composite has fibers extending through cells of the foam to enhance fluid movement between adjacent or adjoining cells in the foam. By enhancing fluid distribution through the foam, the fibers serve to improve the fluid intake and other absorbency characteristics of the foam. Furthermore, the fibers serve to improve the integrity and resiliency of the foam, as well as the article.

Disposable absorbent articles typically include a fluid pervious topsheet, a backsheet joined to the topsheet, and an absorbent core positioned and held between the topsheet and the backsheet. An absorbent article may also include other components, such as fluid wicking layers, fluid intake layers, fluid distribution layers, transfer layers, storage layers, barrier layers, wrapping layers, and the like, as well as combinations thereof.

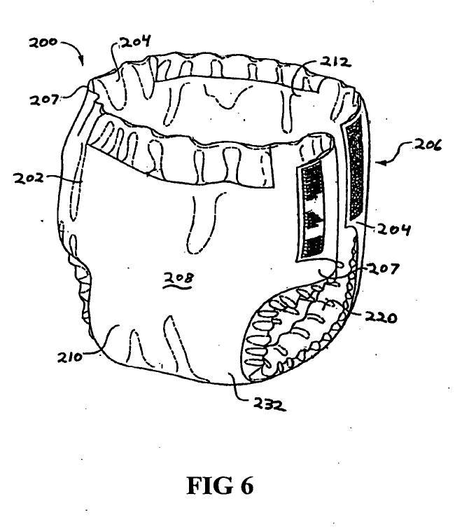

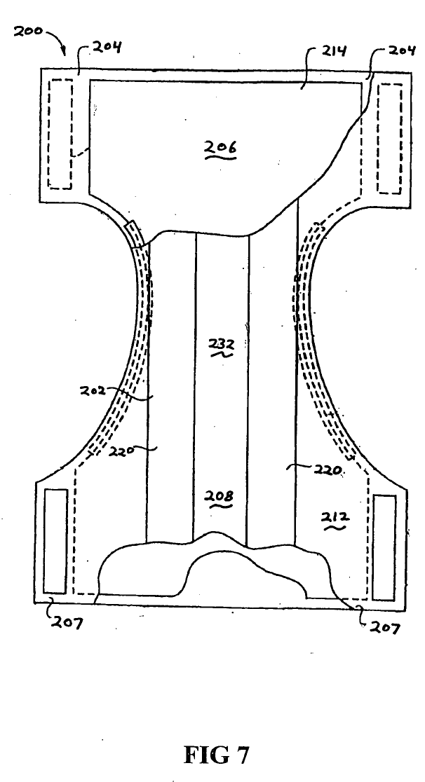

Referring to FIGS. 6 and 7 for exemplary purposes, a training pant which may incorporate the present invention is shown. It is understood that the present invention is suitable for use with various other absorbent articles, including but not limited to other personal care absorbent articles, health/medical absorbent articles, household/industrial absorbent articles, and the like without departing from the scope of the present invention.

Various materials and methods for constructing training pants are disclosed in PCT Patent Application WO 00/37009 published Jun. 29, 2000 by A. Fletcher et al.; U.S. Pat. No. 4,940,464 to Van Gompel et al.; U.S. Pat. No. 5,766,389 to Brandon et al.; and U.S. Pat. No. 6,645,190 to Olson et al., all of which are incorporated herein by reference to the extent they are consistent herewith.

FIG. 6 illustrates a training pant in a partially fastened condition, and FIG. 7 illustrates a training pant in an opened and unfolded state. The training pant defines a longitudinal direction that extends from the front of the training pant when worn to the back of the training pant. Perpendicular to the longitudinal direction is a lateral direction.

The training pant defines a front region, a back region, and a crotch region extending longitudinally between and interconnecting the front and back regions. The pant also defines an inner surface adapted in use (e.g., positioned relative to the other components of the pant) to be disposed toward the wearer, and an outer surface opposite the inner surface. The training pant has a pair of laterally opposite side edges and a pair of longitudinally opposite waist edges.

The illustrated pant 200 may include a chassis 202, a pair of laterally opposite front side panels 204 extending laterally outward at the front region 206, and a pair of laterally opposite back side panels 207 extending laterally outward at the back region 208. The chassis 202 includes an outer cover 210 and a bodyside liner 212 that may be joined to the outer cover 210 in a superimposed relation therewith by adhesives, ultrasonic bonds, thermal bonds, or other conventional techniques. The chassis 202 may further include an absorbent core 214 in the form of the foam composite of the present invention disposed between the outer cover 210 and the bodyside liner 212 for absorbing fluid body exudates exuded by the wearer, and may further include a pair of containment flaps 220 secured to the bodyside liner 212 or the foam composite 214 for inhibiting the lateral flow of body exudates.

The outer cover 210 and the inner liner 212 may be made from many different materials known to those skilled in the art. For instance, they may be extensible and/or elastomeric. Further, the stretch properties of each layer, including the foam composite 214, may vary in order to control the overall stretch properties of the product.

The outer cover 210, for instance, may be breathable and/or may be liquid impermeable. The outer cover 210 may be constructed of a single layer, multiple layers, laminates, spunbond fabrics, films, meltblown fabrics, elastic netting, microporous webs, bonded-carded-webs or foams provided by elastomeric or polymeric materials. The outer cover 210, for instance, can be a single layer of a liquid impermeable material, or alternatively can be a multi-layered laminate structure in which at least one of the layers is liquid impermeable.

The outer cover 210 can be biaxially extensible and optionally biaxially elastic. Elastic non-woven laminate webs that can be used as the outer cover 210 include a non-woven material joined to one or more gatherable non-woven webs, films, or foams. Stretch Bonded Laminates (SBL) and Neck Bonded Laminates (NBL) are examples of elastomeric composites.

Examples of suitable nonwoven materials are spunbond-meltblown fabrics, spunbond-meltblown-spunbond fabrics, spunbond fabrics, meltblown fabrics, or laminates of such fabrics with films, foams, or other nonwoven webs. Elastomeric materials may include cast or blown films, foams, meltblown fabrics, or spunbond fabrics composed of polyethylene, polypropylene, or polyolefin elastomers, as well as combinations thereof. The elastomeric materials may include PEBAX elastomer, HYTREL elastomeric polyester, KRATON elastomer, strands of LYCRA elastomer, or the like, as well as combinations thereof. The outer cover 210 may include materials that exhibit elastomeric properties which have been imparted through a mechanical process, printing process, heating process, or chemical treatment. For example, such materials may be apertured, creped, neck-stretched, heat activated, embossed, and/or micro-strained; and may be in the form of films, webs, and laminates.

Example of a suitable material for a biaxially stretchable outer cover 210 is a breathable elastic film/nonwoven laminate, described in U.S. Pat. No. 5,883,028, to Morman et al., incorporated herein by reference in a manner that is consistent herewith. Examples of materials having two-way stretchability and retractability are disclosed in U.S. Pat. No. 5,116,662 to Morman and U.S. Pat. No. 5,114,781 to Morman, each of which is incorporated herein by reference in a manner that is consistent herewith. These two patents describe composite elastic materials capable of stretching in at least two directions. The materials have at least one elastic sheet and at least one necked material, or reversibly necked material, joined to the elastic sheet at least at three locations arranged in a nonlinear configuration, so that the necked, or reversibly necked, web is gathered between at least two of those locations.

The bodyside liner 212 is suitably compliant, soft-feeling, and non-irritating to the wearer's skin. The bodyside liner 212 is also sufficiently liquid permeable to permit liquid body exudates to readily penetrate through its thickness to the foam composite 214. A suitable bodyside liner 212 may be manufactured from a wide selection of web materials, such as porous foams, reticulated foams, apertured plastic films, woven and non-woven webs, or a combination of any such materials. For example, the bodyside liner 212 may include a meltblown web, a spunbonded web, or a bonded-carded-web composed of natural fibers, synthetic fibers, or combinations thereof. The bodyside liner 212 may be composed of a substantially hydrophobic material, and the hydrophobic material may optionally be treated with a surfactant or otherwise processed to impart a desired level of wettability and hydrophilicity. In one aspect the foam composite of the present invention may be used as the bodyside liner 212.

The bodyside liner 212 may also be extensible or elastomeric. Suitable elastomeric materials for construction of the bodyside liner 212 can include elastic strands, LYCRA elastics, cast or blown elastic films, nonwoven elastic webs, meltblown or spunbond elastomeric fibrous webs, as well as combinations thereof. Examples of suitable elastomeric materials include KRATON elastomers, HYTREL elastomers, ESTANE elastomeric polyurethanes, or PEBAX elastomers. The bodyside liner 212 can also be made from extensible materials as are described in U.S. Pat. No. 6,552,245 to Roessler et al., which is incorporated herein by reference in a manner that is consistent herewith. The bodyside liner 212 can also be made from biaxially stretchable materials as described in U.S. Pat. No. 6,641,134 to Vukos et al., which is incorporated herein by reference in a manner that is consistent herewith.

The article 200 can further comprise an absorbent body structure, and the absorbent body can include the foam composite of the present invention as the absorbent core 214 component. In general, the foam composite can have a significant amount of stretchability and can include absorbent material, such as superabsorbent material as well as fiber. Accordingly, the article can comprise a stretchable thermoplastic foam absorbent core 214 that includes a quantity of fiber and/or superabsorbent material operatively contained within the foam composite. Additionally, the foam composite can include an operative amount of elastomeric polymer.

The foam absorbent core 214 may have any of a number of shapes. For example, the foam absorbent core 214 may be rectangular shaped, triangular shaped, oval shaped, race-track shaped, I-shaped, generally hourglass shaped, T-shaped, or the like. It is often suitable for the absorbent core 214 to be narrower in the crotch portion 232 than the rear 204 or front 202 portion(s). The foam absorbent core 214 can be attached to an absorbent article by bonding means known in the art, such as ultrasonic, pressure, adhesive, heat, sewing thread or strand, autogenous or self-adhering, hook-and-loop, or any combination thereof. For example, the foam absorbent core 214 may be bonded to the topsheet, the backsheet, or both, of an absorbent article.

The present invention may be better understood with reference to the following examples.

### EXAMPLES

### Example 1

In this example, a foam composite of the present invention was prepared in which a base foam layer was needled with a 100 gsm fibrous web layer (in the form of a handsheet) to form a laminate. The base foam was Voltek MINICELL STD crosslinked polyethylene coarse foam.

The handsheet was made using TERRACE BAY LONG LAC-19 (LL-19) bleached northern softwood Kraft pulp available from Neenah Paper, a business having offices located in Alpharetta, Ga. The handsheet was formed using a WILLIAMS STANDARD PULP TESTING APPARATUS (available from Williams Apparatus Company, a business having offices located in Watertown, N.Y. U.S.A.) and was dried.

The base foam was pre-wetted by passing it initially under a hydraulic needling manifold at 100 pisg to ensure that wetting occurred before the process of fiber addition and to ensure uniform fiber embedment into the foam structure. The handsheet (which was large enough to cover the entire base foam layer) was then positioned on top of the pre-wetted base foam layer for a period of about 30 minutes to allow for partial hydration of the handsheet.

The two layers were then positioned, pulp side up, on top of a hydraulic needling 56×40 mesh square weave stainless steel wire (0.29 mm chute diameter, 0.38 mm warp diameter, 0.21 mm free height) and were hydraulically needled using a Honeycomb Systems manifold (available from Honeycomb Systems Inc., a business having offices located in Biddeford, Me. U.S.A.) having a jet strip with 0.005 inch diameter orifices, 40 orifices per linear inch arranged in a single row (available from Nippon Nozzle, a business having offices located in Kobe, Japan). The layers were passed under the manifold twice at a line wire speed of 25 feet per minute and the dewatering vacuum level under the manifold was adjusted to 20 inches of Hg to ensure adequate dewatering. The pressure of the water jets was adjusted to 800 psig to obtain adequate embedment of the fiber into the base foam structure. Each foam composite was then dewatered using the needling wire vacuum and was then air dried overnight.

A comparative sample (Control 1) was also made without fiber and was subjected to the hydraulic jets to isolate the effect of fiber addition. The samples were then tested for various properties, including fluid drop intake, saturated capacity, wicking height, and wicking pickup. The needling parameters can be seen in Table 1a, and the test results can be seen in Table 1b.

TABLE 1a

| | | Composite | | | |
|---|---|---|---|---|---|
| | | Basis | | Manifold | |
| Sample | Foam | Weight | Density | Pressure | Fiber |
| No. | Type | (gsm) | (g/cc) | (psig) | Present? |
| Control 1 | MINICELLSTD | 109 | 0.04 | 800 | No |
| Sample 1 | MINICELLSTD | 205 | 0.06 | 800 | Yes |

*Note, samples that are identified as “Control #” represent comparative examples, while samples that are identified as “Sample #” represent examples of the invention.

TABLE 1b

| | Fluid Drop | | | Wicking |
|---|---|---|---|---|
| Sample | Intake | Capacity | Wicking Height | Pickup |
| No. | (sec) | (g/g) | (cm) | (g/(g/cm²)) |
| Control 1 | >25 | 6.9 | 0 | 18 |
| Sample 1 | 2 | 5.1 | 19.8 | 149 |

* Note, samples that are identified as “Control #” represent comparative examples, while samples that are identified as “Sample #” represent examples of the invention.

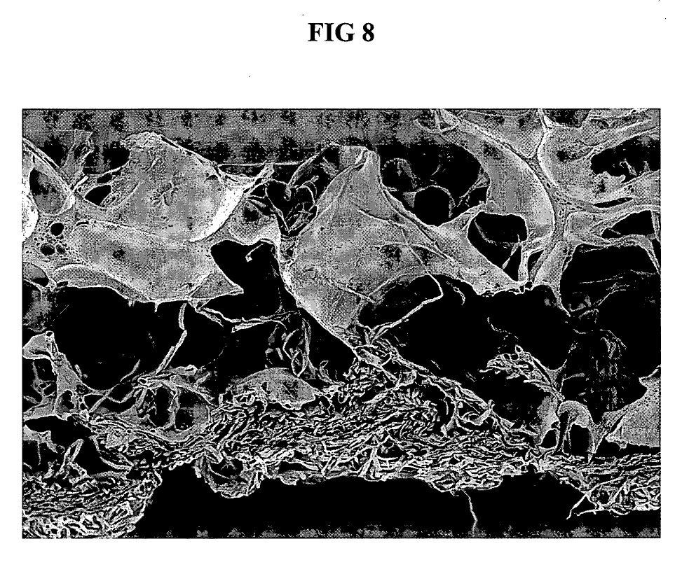

The sample containing fiber demonstrated a more rapid intake of liquid when compared to the corresponding control sample containing no fiber. Likewise, a significant increase in wicking height and wicking pickup was observed for the samples containing fiber. This indicates several benefits of the invention. Consequently, the saturated capacity of the foam with fiber was lower compared to the corresponding sample without fiber. Without wishing to be bound by theory, this could be due to the fibers occupying a portion of the free volume in the interstitial cellular space of the foam. This may be supported by the fact that the wicking height increased with the addition of pulp fibers. A photomicrograph of Sample No. 1 at 30× magnification can be seen in FIG. 8.

### Example 2

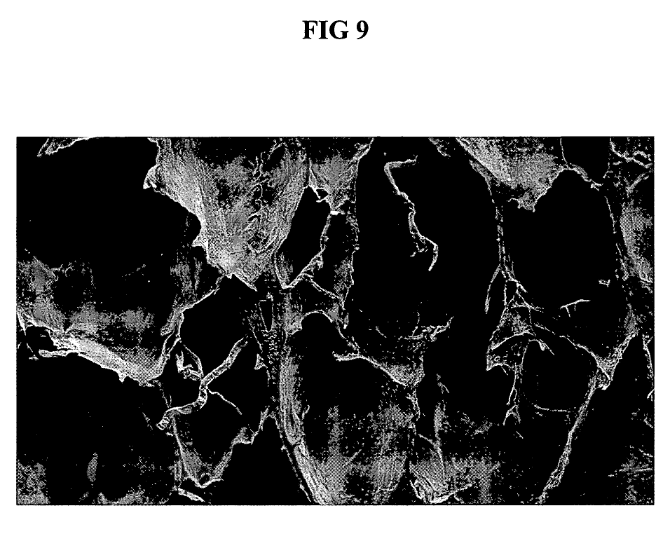

In this example, pellatized Eucalyptus fibers available from Carolina Pelleting and Extrusion, a business having offices located in Newton, N.C. U.S.A., were added in an amount of 4% by weight in a polymer blend comprising 60% by weight STYRON 685-D polystyrene (available from Dow Chemical Company), 32% by weight KRATON G1657 thermoplastic elastomer (available from Kraton Polymers), 3% by weight HOSTASTAT HS-1 (available from Clariant Corporation), and 1% by weight MISTRON VAPOR talc (available from Luzenac America, Inc., a business having offices located in Centennial, Colo. U.S.A.). Carbon dioxide was added as a blowing agent at a 2.1% by weight level with respect to the polymer/fiber blend above. The melt was processed into foam using a 25 mm co-rotating twin screw extruder with a 2 mm diameter circular die (available from American Leistritz Extruder Corporation, a business having offices located in Somerville, N.J., U.S.A.). The melt temperature during extrusion was about 120° C. A photomicrograph of the resulting foam composite at 120× magnification was obtained and is displayed in FIG. 9. The presence of exposed fiber in the free space within the cellular structure can bee seen in this figure.

### Example 3

In this example, a first base foam (K-1) was produced comprising 65.4% by weight STYRON 685 D, 30% by weight of KRATON G1657, 4% by weight HOSTASTAT 3301 (available from Clariant Corporation) and 0.5% by weight MISTRON VAPOR talc. In addition, blowing agents were employed comprising, 0.75% by weight carbon dioxide and 6% by weight iso-pentane, where the weight percent is determined with respect to the polymer and additive blends above.

A second base foam (K-2) comprised 58.6% by weight STYRON 685 D, 30% by weight KRATON G1657, 6% by weight HYDROCEROL CF-40-T (available from Clariant Corporation) and 5.4% by weight HOSTASTAT 3301. In addition, a blowing agent was employed comprising 7% by weight iso-pentane.

Both base foams were formed using a tandem extrusion system similar to that described in U.S. Pat. No. 6,273,697 to Harfmann and U.S. Pat. No. 6,638,985 to Gehlsen (which are incorporated herein by reference in a manner that is consistent herewith), or equivalents. The primary extruder temperature and screw speed were adjusted to ensure complete polymer and additives melting and mixing and the secondary extruder temperature was adjusted to achieve the desired melt temperature profile to produce foam. The die pressure was achieved by controlling the die gap and extruder screw speeds. The process parameters can be seen in Table 2a below.

TABLE 2a
Process conditions for K-1 and K-2

| | Die | | Melt |
|---|---|---|---|
| | Temperature | Die Pressure | Temperature |
| Foam Type | (° F.) | (psig) | (° F.) |
| K-1 | 295 | 976 | 296 |
| K-2 | 295 | 1123 | 289 |

The extruded thermoplastic, soft, flexible, absorbent foams were then each combined with a handsheet comprising LL-19 with a basis weight of about 100 gsm. Each handsheet was formed using a WILLIAMS STANDARD PULP TESTING APPARATUS, and was subsequently dried.

Fibers from each handsheet were then incorporated into the base foam structure using a similar hydraulic needling process as that described in Example 1. In this particular example, the base foam samples were passed through the hydraulic jets at 1500 psig for three passes on each of their two faces. Subsequently, the 100 gsm fiber sheet was laid on top of the wet foam and allowed to hydrate for about one minute. The foam and fiber combination was then passed through the hydraulic jets at 200 psig followed by 3 passes at 500 psig with the fiber portion exposed to the jets. The wire speed was 47 feet per minute.

Comparative examples (Control 2 and Control 3) were also made without fiber and were subjected to the hydraulic jets as described above, to isolate the effect of fiber addition. Each sample was then dewatered using the needling wire vacuum and air dried overnight. The samples were then tested for various properties, including fluid drop intake, saturated capacity, wicking height, and wicking pickup, the results of which can be seen in Tables 2b and 2c below.

TABLE 2b

| | | Basis | | |
|---|---|---|---|---|
| Sample | | Weight | Density | Fiber |
| No. | Foam Type | (gsm) | (g/cc) | Addition |
| Control 2 | K-1 | 124 | 0.07 | No |
| Sample 2 | K-1 | 240 | 0.09 | Yes |
| Control 3 | K-2 | 171 | 0.12 | No |
| Sample 3 | K-2 | 283 | 0.12 | Yes |

* Note, samples that are identified as “Control #” represent comparative examples, while samples that are identified as “Sample #” represent examples of the invention.

TABLE 2c

| | | | | | Bending |
|---|---|---|---|---|---|
| | Fluid | | | | modulus @ |
| | Drop | Saturated | Wicking | Wicking | 0.5 mm |
| Sample | Intake | Capacity | height | pickup | deflection |
| No. | (sec) | (g/g) | (cm) | (g/g/cm²) | (g/mm²) |
| Control 2 | <1 | 8.0 | 8.1 | 124 | 390 |
| Sample 2 | <1 | 6.3 | 14.2 | 151 | 305 |
| Control 3 | <1 | 4.3 | 10.8 | 107 | 123 |
| Sample 3 | <1 | 3.9 | 14.8 | 120 | 124 |

*Note, samples that are identified as “Control #” represent comparative examples, while samples that are identified as “Sample #” represent examples of the invention.

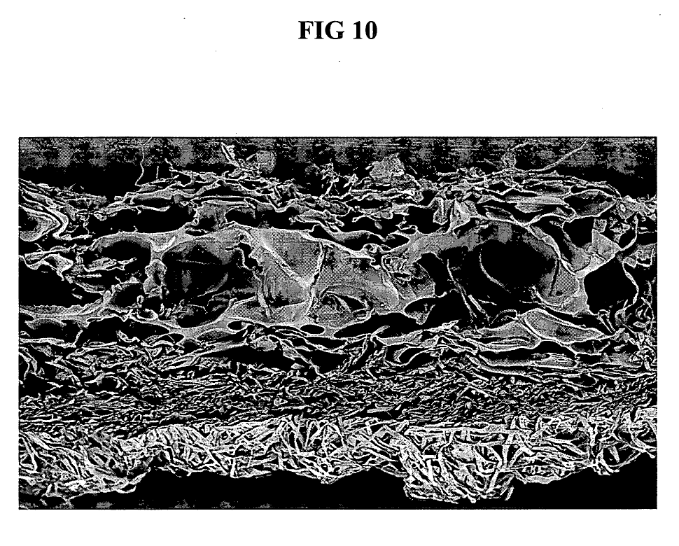

The addition of fiber is seen to enhance wicking height and pick up. Also, the impact of fiber addition does not seem to affect the bending modulus in a negative manner, which indicated a sufficient degree of flexibility. A photomicrograph of Sample No. 2 at 30× magnification can be seen in FIG. 10.

Test Methods

Saturated Capacity Test

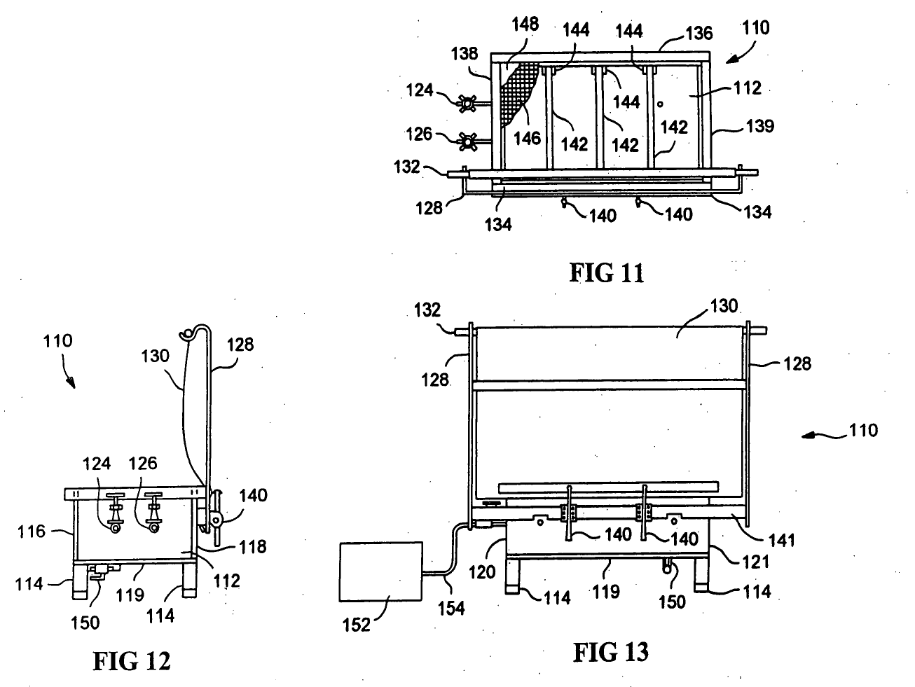

Saturated Capacity is determined using a Saturated Capacity (SAT CAP) tester with a Magnahelic vacuum gage and a latex dam, comparable to the following description. Referring to FIGS. 11-13, a Saturated Capacity tester vacuum apparatus 110 comprises a vacuum chamber 112 supported on four leg members 114. The vacuum chamber 112 includes a front wall member 116, a rear wall member 118, and two side walls 120 and 121. The wall members are sufficiently thick to withstand the anticipated vacuum pressures, and are constructed and arranged to provide a chamber having outside dimensions measuring 23.5 inches in length, 14 inches in width and 8 inches in depth.

A vacuum pump (not shown) operably connects with the vacuum chamber 112 through an appropriate vacuum line conduit and a vacuum valve 124. In addition, a suitable air bleed line connects into the vacuum chamber 112 through an air bleed valve 126. A hanger assembly 128 is suitably mounted on the rear wall 118 and is configured with S-curved ends to provide a convenient resting place for supporting a latex dam sheet 130 in a convenient position away from the top of the vacuum apparatus 110. A suitable hanger assembly can be constructed from 0.25 inch diameter stainless steel rod. The latex dam sheet 130 is looped around a dowel member 132 to facilitate grasping and to allow a convenient movement and positioning of the latex dam sheet 130. In the illustrated position, the dowel member 132 is shown supported in a hanger assembly 128 to position the latex dam sheet 130 in an open position away from the top of the vacuum chamber 112.

A bottom edge of the latex dam sheet 130 is clamped against a rear edge support member 134 with suitable securing means, such as toggle clamps 140. The toggle clamps 140 are mounted on the rear wall member 118 with suitable spacers 141 which provide an appropriate orientation and alignment of the toggle clamps 140 for the desired operation. Three support shafts 142 are 0.75 inches in diameter and are removably mounted within the vacuum chamber 112 by means of support brackets 144. The support brackets 144 are generally equally spaced along the front wall member 116 and the rear wall member 118 and arranged in cooperating pairs. In addition, the support brackets 144 are constructed and arranged to suitably position the uppermost portions of the support shafts 142 flush with the top of the front, rear and side wall members of the vacuum chamber 112. Thus, the support shafts 142 are positioned substantially parallel with one another and are generally aligned with the side wall members 120 and 121. In addition to the rear edge support member 134, the vacuum apparatus 110 includes a front support member 136 and two side support members 138 and 139. Each side support member measures about 1 inch in width and about 1.25 inches in height. The lengths of the support members are constructed to suitably surround the periphery of the open top edges of the vacuum chamber 112, and are positioned to protrude above the top edges of the chamber wall members by a distance of about 0.5 inches.

A layer of egg crating type material 146 is positioned on top of the support shafts 142 and the top edges of the wall members of the vacuum chamber 112. The egg crate material extends over a generally rectangular area measuring 23.5 inches by 14 inches, and has a depth measurement of about 0.38 inches. The individual cells of the egg crating structure measure about 0.5 inch square, and the thin sheet material comprising the egg crating is composed of a suitable material, such as polystyrene. For example, the egg crating material can be McMaster-Carr Supply Catalog No. 162 4K 14 (available from McMaster-Carr Supply Company, a business having offices located in Atlanta, Ga. U.S.A.), translucent diffuser panel material. A layer of 6 mm (0.25 inch) mesh TEFLON-coated screening 148, available from Eagle Supply and Plastics, Inc., a business having offices located in Appleton, Wis., U.S.A., which measures 23.5 inches by 14 inches, is placed on top of the egg crating material 146.

A suitable drain line and a drain valve 150 connect to the bottom plate member 119 of the vacuum chamber 112 to provide a convenient mechanism for draining liquids from the vacuum chamber 112. The various wall members and support members of the vacuum apparatus 110 may be composed of a suitable non-corroding, moisture-resistant material, such as polycarbonate plastic. The various assembly joints may be affixed by solvent welding and/or fasteners, and the finished assembly of the tester is constructed to be water-tight. A vacuum gauge 152 operably connects through a conduit into the vacuum chamber 112. A suitable pressure gauge is a Magnahelic differential gauge capable of measuring a vacuum of 0-100 inches of water, such as a No. 2100 gauge available from Dwyer Instrument Incorporated, a business having offices located in Michigan City, Ind., U.S.A.

The dry product or other absorbent structure is weighed and then placed in excess 0.9% NaCl saline solution, submerged and allowed to soak for twenty (20) minutes. After the twenty (20) minute soak time, the absorbent structure is placed on the egg crate material and mesh TEFLON-coated screening of the Saturated Capacity tester vacuum apparatus 110. The latex dam sheet 130 is placed over the absorbent structure(s) and the entire egg crate grid so that the latex dam sheet 130 creates a seal when a vacuum is drawn on the vacuum apparatus 110. A vacuum of 0.5 pounds per square inch (psi) is held in the Saturated Capacity tester vacuum apparatus 110 for five minutes. The vacuum creates a pressure on the absorbent structure(s), causing drainage of some liquid. After five minutes at 0.5 psi vacuum, the latex dam sheet 130 is rolled back and the absorbent structure(s) are weighed to generate a wet weight.

The overall capacity of each absorbent structure is determined by subtracting the dry weight of each absorbent from the wet weight of that absorbent, determined at this point in the procedure. The 0.5 psi Saturated Capacity or Saturated Capacity of the absorbent structure is determined by the following formula:
Saturated Capacity=(wet weight−dry weight)/dry weight;
wherein the Saturated Capacity value has units of grams of fluid/gram of absorbent. For Saturated Capacity, a minimum of four specimens of each sample should be tested and the results averaged. If the absorbent structure has low integrity or disintegrates during the soak or transfer procedures, the absorbent structure can be wrapped in a containment material such as paper toweling, for example SCOTT paper towels manufactured by Kimberly-Clark Corporation, a business having offices located in Neenah, Wis., U.S.A. The absorbent structure can be tested with the overwrap in place and the capacity of the overwrap can be independently determined and subtracted from the wet weight of the total wrapped absorbent structure to obtain the wet absorbent weight.
Wicking Height Test and Wicking Pickup Test

A sample of foam is cut to 2.5 cm width and of a sufficient length, L (measured in cm), such that the liquid does not reach the top of the sample during the test. The sample is weighed and the dry mass (m) is recorded in grams. The basis weight of the sample is calculated by dividing the dry mass (m) by the area (L multiplied by 2.5) and expressed in grams/cm².

The sample is mounted so that it hangs in a vertical orientation to gravity with the exposed 2.5 cm foam edge in a substantially horizontal orientation. A sufficiently large reservoir of 0.9% NaCl saline test solution is raised, using a standard lab jack, so that the foam's horizontal edge extends approximately 2 millimeters beneath the surface of the saline. A timer is started simultaneous to the penetration of the foam into the saline. After thirty (30) minutes, the height of the fluid in the foam is measured relative to the surface of the saline. This is designated as the Wicking Height in centimeters. If desired, the saline can contain a non-surface active, non-chromatographic dye to aid in identifying the penetration and wicking of the test fluid within the foam. Alternatively, the foam may be marked at the surface of the fluid and the fluid reservoir lowered to remove further contact with the foam. To compensate for possible foam expansion upon hydration, the foam may be marked at the fluid surface after the wicking time.

Measurement of the fluid height in the foam using the initial foam dimensions may be done via any appropriate means including x-ray imaging, optical measurement, or slicing sections of the foam until 0.9% NaCl saline test solution is apparent in the slice. In addition to the height of liquid rise, the amount of liquid picked up is also measured at the end of thirty (30) minutes. This value is corrected to account for the portion of the sample under the liquid level and normalized by the sample basis weight obtained above to provide the Wicking Pickup value, expressed in grams of liquid per grams per square centimeter (g/g/cm²).

Drop Intake Test

A sample of foam of suitable size (greater than 5 cm×5 cm) is cut from a sheet. The face on which the drop intake is to be measured and is placed face up on an impermeable surface such as a lab bench. (Laminate/layered configuration materials were tested for drop intake on the non-pulp face of the foam). A syringe pump (such as a Harvard Apparatus 44, available from Harvard Apparatus, a business having offices located in Holliston, Mass. U.S.A.) was set up to deliver 0.03 ml of liquid via a capillary tube (inner diameter=1.1 mm) such that exactly 1 drop of saline was dispensed. The tip of the capillary tube was held at a constant height of 1.5 cm above the sample for the test. A stop watch was started as soon as the pump dispensed the drop and the time taken for the drop to disappear into the material was measured.

For samples of varying geometry, the sample dimensions may be suitably modified taking into consideration that the sample needs to be larger than the drop being tested and the face on which drop intake is being measured should be horizontal and perpendicular to the capillary dispensing the drop.

Bending Modulus Test

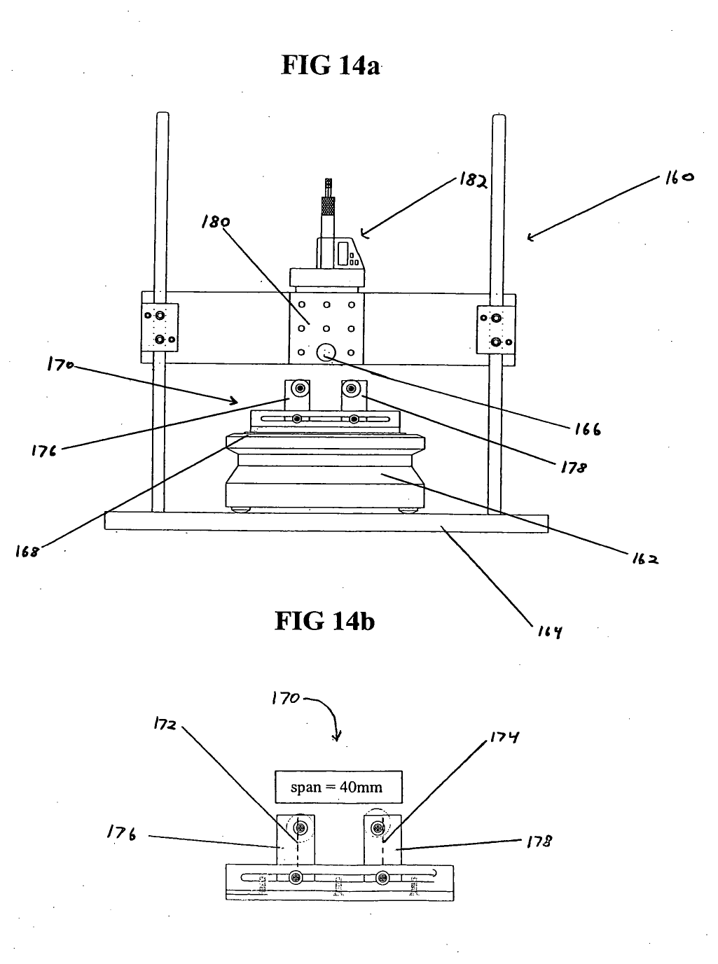

This test is similar to that described in ASTM D 5934. Samples are cut to have dimensions of 64 mm long×38 mm wide (W). The thickness of the sample (T) is then measured in millimeters. With reference to FIG. 14, assemble the apparatus 160 so that the balance 162 is completely on the baseboard 164, and the loading nose 166 is centered over the weigh pan 168. The fixture base 170 should be inspected to be sure that the distance between the centers 172, 174 of the two cylinders 176, 178 (S) is 40 mm.

The fixture base 170 should be placed on the weigh pan 168 so that the two cylinders 176, 178 are parallel with the cylinder on the loading nose 166. The caliper 182 should be adjusted to lower the assembly 180 with the loading nose 166 in order to be sure that the loading nose 166 is parallel to the bottom cylinders 176, 178. The sample (not shown) should then be laid across the bottom cylinders 176, 178 with the longer dimension along the span. The loading nose 166 should not touch the sample. At this point, the balance 162 should be tared.

Dial the caliper 182 to move assembly 180 down so that the loading nose 166 just touches the sample and the balance 162 reading (load) is 0.5 g. Then zero the caliper 182; this will be the reference point for deflection measurements. Set a timer (not shown) for 2 minutes. Dial the caliper 182 to move the loading nose 166 down to 0.25 mm distance (D) then start the timer. (Be sure not to pass 0.25 mm. If it is passed, do not dial back up, simply continue onto the next deflection.) Record the load (F) in grams after 2 minutes. Repeat at other distances of 0.5 mm, 0.75 mm, and 1 mm, then discard the sample. The Bending Modulus (BM) at each deflection can be calculated in g/mm² using the following formula:

$$BM = \frac{F ( {S}^{3} )}{4 D ( {T}^{3} ) W}$$

Viscous Fluid Saturated Capacity and Retention Capacity Test

The viscous saturation capacity and the viscous retention capacity can be determined by soaking a 3.81 cm×3.81 cm×2 mm (a comparable 14.5 square centimeter surface area if smaller samples are tested, and if thicker samples are used, they will need to be sliced down using conventional non-densifying means) sample of absorbent foam in approximately 30 milliliters of a menses simulant test fluid (described below) in a plastic dish that is sufficient to fully saturate the sample for thirty minutes. The pre-weighed foam is placed on a strip of scrim-like material (for sample handling), then placed into the 30 milliliters of test fluid making sure fluid completely covers the sample. The dish is covered so evaporation does not occur. While soaking thirty minutes, the test fluid amount is monitored so that there is always excess fluid. The foam sample is then removed using the scrim and placed between two pieces of approximately 4-inch by 4-inch through-air-bonded-carded web material and on the outside of this sandwich, a layer of approximately 4-inch by 4-inch blotter paper is positioned on each side such that the blotter paper is facing the outside. A description of these materials is provided below. A pressure of 0.05 psi (0.345 KPa) is applied for five minutes to remove any pools of liquid. The saturated sample is then weighed. The weight of the liquid held in the foam sample divided by the dry weight of the foam sample is the saturation capacity of the sample.

After the saturated foam sample is weighed, the absorbent foam sample is placed in a centrifuge and spun at 300 G for three minutes so that the free fluid is discharged. The spun foam sample is then weighed. The weight of the liquid remaining in the spun foam sample divided by the dry weight of the sample is the retention capacity of the foam sample.

Accordingly:
Saturation Capacity=(Wet Wt. Before Centrifuge−Dry Wt.)/(Dry Wt.) a.
Retention Capacity=(Wet Wt. After Centrifuge−Dry Wt.)/(Dry Wt.) b.

A suitable through-air-bonded-carded web material has a 2.5 osy (84.8 g/m2) basis weight, a 0.024 g/cm³ density, and is composed of 60 wt % of 6 denier, KoSa type 295 polyester fiber; and 40% by weight of 3 denier, Chisso ESC-HR6 bicomponent fiber. The polyester fiber is available from KoSa, a business having offices located in Charlotte, N.C., U.S.A., and the bicomponent fiber is available from Chisso Corporation, a business having offices located in Osaka, Japan. A suitable blotter paper is 100-lb VERIGOOD white blotter paper available from Georgia Pacific Corporation, a business having offices located in Menasha, Wis., U.S.A. (e.g., product item number 411 01012). Substantially equivalent materials may optionally be employed.

The “menses simulant” test fluid is composed of swine blood diluted with swine plasma to provide a hematocrit level of 35% (by volume). A suitable device for determining the hematocrit level is a HEMATOSTAT-2 system, available from Separation Technology, Inc., a business having offices located in Altamonte Springs, Fla., U.S.A. A substantially equivalent system may alternatively be employed.

It will be appreciated that details of the foregoing examples, given for purposes of illustration, are not to be construed as limiting the scope of this invention. Although only a few exemplary embodiments of this invention have been described in detail above, those skilled in the art will readily appreciate that many modifications are possible in the examples without materially departing from the novel teachings and advantages of this invention. For example, features described in relation to one example may be incorporated into any other example of the invention.

Accordingly, all such modifications are intended to be included within the scope of this invention, which is defined in the following claims and all equivalents thereto. Further, it is recognized that many embodiments may be conceived that do not achieve all of the advantages of some embodiments, particularly of the preferred embodiments, yet the absence of a particular advantage shall not be construed to necessarily mean that such an embodiment is outside the scope of the present invention. As various changes could be made in the above constructions without departing from the scope of the invention, it is intended that all matter contained in the above description shall be interpreted as illustrative and not in a limiting sense.

What is claimed is:

1. A flexible, absorbent, thermoplastic foam comprising a thermoplastic base resin and fibers.

2. The flexible, absorbent, thermoplastic foam of claim 1 wherein said foam has an open-cell content of about 50% or greater.

3. The flexible, absorbent, thermoplastic foam of claim 1 wherein said base resin is selected from the group consisting of alkenyl aromatics, styrene copolymers, polyolefins, polyesters, and combinations thereof.

4. The flexible, absorbent, thermoplastic foam of claim 1 wherein said fibers are present in an amount between about 2% and about 50% by weight.

5. The flexible, absorbent, thermoplastic foam of claim 1 wherein said fibers are hydrophilic.

6. The flexible, absorbent, thermoplastic foam of claim 1 wherein said fibers are natural fibers.

7. The flexible, absorbent, thermoplastic foam of claim 6 wherein said natural fibers have a fiber length of about 5 millimeters or less.

8. The flexible, absorbent, thermoplastic foam of claim 6 wherein said natural fibers have a fiber length between about 0.5 millimeters and about 5 millimeters.

9. The flexible, absorbent, thermoplastic foam of claim 1 wherein said fiber is incorporated into said flexible, absorbent, thermoplastic foam through a post foam formation means.

10. The flexible, absorbent, thermoplastic foam of claim 9 wherein said post foam formation means is a hydraulic needling process.

11. The flexible, absorbent, thermoplastic foam of claim 1 further comprising between about 5% and about 50% by weight thermoplastic elastomer.

12. The flexible, absorbent, thermoplastic foam of claim 11 wherein said thermoplastic elastomer comprises at least one of the group consisting of styrenic block copolymers including diblock and triblock copolymers which may include styrene-isoprene-styrene (SIS), styrene-butadiene-styrene (SBS), styrene-isoprene-butadiene-styrene (SIBS), styrene-ethylene/butylene-styrene (SEBS), styrene-ethylene/propylene-styrene (SEPS); polyolefin-based thermoplastic elastomers including random block copolymers including ethylene α-olefin copolymers; block copolymers including hydrogenated butadiene-isoprene-butadiene block copolymers; stereoblock polypropylenes; graft copolymers, including ethylene-propylene-diene terpolymer (EPDM), ethylene-propylene random copolymers (EPM) and ethylene propylene rubbers (EPR); blends of thermoplastic elastomers with dynamic vulcanized elastomer-thermoplastic blends; thermoplastic polyether-ester elastomers; ionomeric thermoplastic elastomers; polyamide thermoplastic elastomers; and combinations thereof.

13. The flexible, absorbent, thermoplastic foam of claim 11 wherein said thermoplastic elastomer has a diblock content between about 50% and about 80% by weight of said thermoplastic elastomer.

14. The flexible, absorbent, thermoplastic foam of claim 1 further comprising between about 0.05% and about 10% by weight surfactant.

15. The flexible, absorbent, thermoplastic foam of claim 14 wherein said surfactant is anionic.

16. The flexible, absorbent, thermoplastic foam of claim 14 wherein said surfactant is a multi-component surfactant.

17. The flexible, absorbent, thermoplastic foam of claim 1 having a density in the range of about 0.03 g/cc to about 0.5 g/cc.

18. The flexible, absorbent, thermoplastic foam of claim 17 having a density in the range of about 0.06 g/cc to about 0.12 g/cc.

19. The flexible, absorbent, thermoplastic foam of claim 1 having a cell size in the range of about 10 microns to about 1000 microns.

20. The flexible, absorbent, thermoplastic foam of claim 1 having a saturated capacity of about 3 grams/gram or greater as measured under a 0.5 psi loading.

21. The flexible, absorbent, thermoplastic foam of claim 1 having a bending modulus at 0.5 mm deflection of about 500 g/mm2 or less as measured by the Bending Modulus Test.

22. The flexible, absorbent, thermoplastic foam of claim 21 having a bending modulus at 0.5 mm deflection of between about 124 g/mm² and 305 g/mm² as measured by the Bending Modulus Test.

23. The flexible, absorbent, thermoplastic foam of claim 1 having a wicking height of about 5 cm or greater as measured by the Wicking Height Test.

24. The flexible, absorbent, thermoplastic foam of claim 23 having a wicking height of between about 14.2 cm and 19.8 cm as measured by the Wicking Height Test.

25. The flexible, absorbent, thermoplastic foam of claim 1 having a Wicking Pickup of 100 g/g/cm² or greater as measured by the Wicking Pickup Test.

26. The flexible, absorbent, thermoplastic foam of claim 25 having a Wicking Pickup between about 120 g/g/cm² and 151 g/g/cm² as measured by the Wicking Pickup Test.

27. The flexible, absorbent, thermoplastic foam of claim 1 having a fluid drop intake of about 2 seconds or less as measured by the Fluid Drop Intake Test.

28. A laminate comprising the flexible, absorbent, thermoplastic foam of claim 1.

29. An article comprising the flexible, absorbent, thermoplastic foam of claim 1.

30. A flexible, absorbent, open-cell, thermoplastic foam comprising a thermoplastic base resin and fibers;
wherein said flexible, absorbent, open-cell, thermoplastic foam comprises cells defined by cell membranes that are substantially non-absorbent;
wherein said fibers have a length of about 0.5 mm to about 5.0 mm and extend through said cell membranes into said cells; and
wherein said flexible, absorbent, open-cell, thermoplastic foam has a density between about 0.03 g/cc and about 0.5 g/cc.

31. The flexible, absorbent, thermoplastic foam of claim 30 wherein said fiber is incorporated into said flexible, absorbent, thermoplastic foam through a post foam formation means.

32. The flexible, absorbent, thermoplastic foam of claim 31 wherein said post foam formation means is a hydraulic needling process.

33. The flexible, absorbent, thermoplastic foam of claim 30 wherein said density is between about 0.06 g/cc and about 0.12 g/cc.

34. An article comprising the thermoplastic foam of claim 30.

35. An open-cell, thermoplastic foam comprising between about 50% and about 95% by weight of an alkenyl aromatic base resin, between about 10% and about 50% by weight of thermoplastic elastomer between about 0.05% and about 10% by weight of surfactant, and between about 1% and about 90% by weight of cellulosic fiber, wherein said thermoplastic elastomer has a styrenic block copolymer thermoplastic elastomer diblock content of between about 50% and about 80% by weight.

36. An article comprising the thermoplastic foam of claim 35.
